(19) United States
(12) Patent Application Publication
(10) Pub. No.: US 2026/0362324 A1
(43) Pub. Date: Nov. 12, 2026

(54) CONDITIONS TO ADJUST AN AMPLIFIER FOR ENERGY HARVESTING DEVICES

(71) Applicant: QUALCOMM Incorporated, San Diego, CA (US)

(72) Inventors: Zhikun WU, Beijing (CN); Ahmed ELSHAFIE, San Diego, CA (US); Yuchul KIM, San Diego, CA (US); Wei YANG, San Diego, CA (US); Linhai HE, San Diego, CA (US)

(21) Appl. No.: 19/153,577

(22) PCT Filed: Mar. 24, 2023
(86) PCT No.: PCT/CN2023/083619

§ 371 Date: Aug. 4, 2025

(51) Int. Cl. H04W 52/02; H02J 50/00; H02J 50/80

(52) U.S. Cl. CPC H04W 52/0225; H02J 50/001; H02J 50/80

(57) ABSTRACT

Methods, systems, and devices for wireless communication are described. Techniques described herein include providing and using conditions to adjust an operating status of an amplifier in energy-harvesting (EH) devices. For example, a reader device (e g., user equipment (UE) or network entity) may evaluate one or more criteria based on communications with the EH device. The reader may transmit control signaling to adjust the amplifier based on evaluating the one or more criteria. Additionally, or alternatively, the EH device itself may evaluate the criteria and adjust the amplifier based on the evaluations. The EH device may adjust a gain to the amplifier or may activate or deactivate the amplifier.

### CROSS REFERENCE

The present Application for Patent is a 371 national phase filing of International Patent Application No. PCT/CN2023/083619 by WU et al., entitled “CONDITIONS TO ADJUST AN AMPLIFIER FOR ENERGY HARVESTING DEVICES,” filed Mar. 24, 2023, assigned to the assignee hereof, and expressly incorporated by reference herein.

### FIELD OF TECHNOLOGY

The following relates to wireless communication, including conditions to adjust an amplifier for energy harvesting devices.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support conditions to adjust an amplifier for energy harvesting devices. For example, the described techniques provide for conveying and relying on conditions to adjust an operating status of an amplifier in energy harvesting (EH) devices. For example, a reader device (e.g., user equipment (UE) or network entity) may evaluate one or more criteria based on communications with an EH device, and then the reader may transmit control signaling to adjust the amplifier of the EH device based on the evaluations. In an alternative scenario, an energy-providing device (e.g., a UE or network entity that provides energy to the EH device) may be the device that evaluates the one or more criteria and may transmit the control signaling to adjust the amplifier of the EH device. Additionally, or alternatively, the EH device itself may evaluate the criteria and adjust the amplifier based on the evaluations.

A method for wireless communications at an energy harvesting (EH)-capable device is described. The method may include identifying one or more criteria associated with an operating status of an amplifier of the EH-capable device, where the EH-capable device is configured to transition between an energy harvesting state and an active state in accordance with an energy level of a power source associated with the EH-capable device, evaluating the one or more criteria based on an operating condition at the EH-capable device, and updating the operating status of the amplifier in accordance with the operating condition and the evaluation of the one or more criteria.

An apparatus for wireless communications at an energy harvesting (EH)-capable device is described. The apparatus may include a processor, memory coupled with the processor, and instructions stored in the memory. The instructions may be executable by the processor to cause the apparatus to identify one or more criteria associated with an operating status of an amplifier of the EH-capable device, where the EH-capable device is configured to transition between an energy harvesting state and an active state in accordance with an energy level of a power source associated with the EH-capable device, evaluate the one or more criteria based on an operating condition at the EH-capable device, and update the operating status of the amplifier in accordance with the operating condition and the evaluation of the one or more criteria.

Another apparatus for wireless communications at an energy harvesting (EH)-capable device is described. The apparatus may include means for identifying one or more criteria associated with an operating status of an amplifier of the EH-capable device, where the EH-capable device is configured to transition between an energy harvesting state and an active state in accordance with an energy level of a power source associated with the EH-capable device, means for evaluating the one or more criteria based on an operating condition at the EH-capable device, and means for updating the operating status of the amplifier in accordance with the operating condition and the evaluation of the one or more criteria.

A non-transitory computer-readable medium storing code for wireless communications at an energy harvesting (EH)-capable device is described. The code may include instructions executable by a processor to identify one or more criteria associated with an operating status of an amplifier of the EH-capable device, where the EH-capable device is configured to transition between an energy harvesting state and an active state in accordance with an energy level of a power source associated with the EH-capable device, evaluate the one or more criteria based on an operating condition at the EH-capable device, and update the operating status of the amplifier in accordance with the operating condition and the evaluation of the one or more criteria.

Some examples of the method, apparatuses, and non-transitory computer-readable medium described herein may further include operations, features, means, or instructions for transmitting, to a wireless communication device, information indicative of the updated operating status of the amplifier.

In some examples of the method, apparatuses, and non-transitory computer-readable medium described herein, identifying the one or more criteria may include operations, features, means, or instructions for receiving, from a wireless communication device, information indicative of the one or more criteria, where the one or more criteria may be evaluated based on receiving the information.

In some examples of the method, apparatuses, and non-transitory computer-readable medium described herein, updating the operating status of the amplifier may include operations, features, means, or instructions for adjusting a gain of the amplifier, activating the amplifier, or deactivating the amplifier based on evaluating the one or more criteria.

In some examples of the method, apparatuses, and non-transitory computer-readable medium described herein, evaluating the one or more criteria may include operations, features, means, or instructions for evaluating, as the operating condition, the energy level of the power source relative to the one or more criteria, where the operating status may be updated based on the energy level.

In some examples of the method, apparatuses, and non-transitory computer-readable medium described herein, evaluating the energy level may include operations, features, means, or instructions for determining whether the energy level may be greater than an energy level threshold.

In some examples of the method, apparatuses, and non-transitory computer-readable medium described herein, updating the operating status of the amplifier may include operations, features, means, or instructions for activating the amplifier based on determining that the energy level may be greater than the energy level threshold.

In some examples of the method, apparatuses, and non-transitory computer-readable medium described herein, updating the operating status of the amplifier may include operations, features, means, or instructions for deactivating the amplifier based on determining that the energy level may be less than the energy level threshold.

Some examples of the method, apparatuses, and non-transitory computer-readable medium described herein may further include operations, features, means, or instructions for determining that the energy level corresponds to an energy state of a set of multiple energy states, where the updated operating status corresponds to the energy state.

In some examples of the method, apparatuses, and non-transitory computer-readable medium described herein, each energy state of the set of multiple energy states may be associated with a respective operating status of the amplifier.

In some examples of the method, apparatuses, and non-transitory computer-readable medium described herein, evaluating the energy level may include operations, features, means, or instructions for evaluating a charging rate or a discharging rate of the power source.

In some examples of the method, apparatuses, and non-transitory computer-readable medium described herein, the power source may be a battery.

In some examples of the method, apparatuses, and non-transitory computer-readable medium described herein, evaluating the one or more criteria may include operations, features, means, or instructions for evaluating, as the operating condition, a reference signal measurement relative to the one or more criteria, where the operating status may be updated based on the reference signal measurement.

In some examples of the method, apparatuses, and non-transitory computer-readable medium described herein, the reference signal measurement may be a reference signal received power, a reference signal received quality, a signal to interference and nose ratio, a reference signal pathloss, a received signal strength, or a combination thereof.

In some examples of the method, apparatuses, and non-transitory computer-readable medium described herein, the one or more criteria include one or more reference signal measurement thresholds.

In some examples of the method, apparatuses, and non-transitory computer-readable medium described herein, the one or more criteria include a delta in the reference signal measurement relative to a prior reference signal measurement.

Some examples of the method, apparatuses, and non-transitory computer-readable medium described herein may further include operations, features, means, or instructions for identifying, as the operating condition, a communication parameter for communications with a wireless communication device, where the operating status may be updated based on the identified communication parameter.

In some examples of the method, apparatuses, and non-transitory computer-readable medium described herein, the communication parameter includes a data rate, a symbol duration, a modulation and coding scheme, a traffic priority, a reliability target, a packet error rate, or a combination thereof.

Some examples of the method, apparatuses, and non-transitory computer-readable medium described herein may further include operations, features, means, or instructions for transmitting, to a wireless communication device, feedback corresponding to a communication received from the wireless communication device, where the operating status may be updated based on whether the feedback may be an acknowledgment or a negative acknowledgment.

In some examples of the method, apparatuses, and non-transitory computer-readable medium described herein, evaluating the one or more criteria may include operations, features, means, or instructions for determining that a quantity of consecutive negative acknowledgments corresponding to communications received from a wireless communication device satisfies a threshold quantity of negative acknowledgments, where the operating status may be updated based on the threshold quantity of negative acknowledgments being satisfied.

In some examples of the method, apparatuses, and non-transitory computer-readable medium described herein, evaluating the one or more criteria may include operations, features, means, or instructions for determining, as the operating condition, a distance between the EH-capable device and a wireless communication device, where the operating status may be updated based on the distance.

In some examples of the method, apparatuses, and non-transitory computer-readable medium described herein, evaluating the one or more criteria may include operations, features, means, or instructions for determining that a timer associated with a current operating status may be expired, where the operating condition may be updated based on expiration of the timer.

Some examples of the method, apparatuses, and non-transitory computer-readable medium described herein may further include operations, features, means, or instructions for receiving, from a wireless communication device, information indicating one or more times for adjusting the operating condition for the amplifier, where the operating condition may be updated based on the one or more times.

In some examples of the method, apparatuses, and non-transitory computer-readable medium described herein, receiving the information indicating the one or more times may include operations, features, means, or instructions for receiving layer 1 signaling, layer 2 signaling, layer 3 signaling, or a combination thereof.

In some examples of the method, apparatuses, and non-transitory computer-readable medium described herein, the information indicates the one or more times using one or more timers, as one or more slots or symbols, cycle conditions, or a combination thereof.

In some examples of the method, apparatuses, and non-transitory computer-readable medium described herein, evaluating the one or more criteria may include operations, features, means, or instructions for evaluating, as the operating condition, a current status of a discontinuous reception cycle associated with the EH-capable device, where the operating status may be updated based on the current status of the discontinuous reception cycle.

In some examples of the method, apparatuses, and non-transitory computer-readable medium described herein, evaluating the one or more criteria may include operations, features, means, or instructions for receiving, from a wireless communication device and as the operating condition, a wake up signal, where the operating status may be updated based on receiving the wake up signal.

In some examples of the method, apparatuses, and non-transitory computer-readable medium described herein, the amplifier may be a low-noise amplifier, a power amplifier, a tunnel diode, or a combination thereof.

A method for wireless communication at a wireless communications device is described. The method may include identifying one or more criteria associated with an operating status of an amplifier of an energy harvesting (EH)-capable device, where the EH-capable device is configured to transition between an energy harvesting state and an active state in accordance with an energy level of a power source associated with EH-capable device, evaluating the one or more criteria based on communications with the EH capable device, and transmitting, to the EH-capable device based on evaluating the one or more criteria, information that is configured to update the operating status of the amplifier of the EH-capable device.

An apparatus for wireless communication at a wireless communications device is described. The apparatus may include a processor, memory coupled with the processor, and instructions stored in the memory. The instructions may be executable by the processor to cause the apparatus to identify one or more criteria associated with an operating status of an amplifier of an energy harvesting (EH)-capable device, where the EH-capable device is configured to transition between an energy harvesting state and an active state in accordance with an energy level of a power source associated with EH-capable device, evaluate the one or more criteria based on communications with the EH capable device, and transmit, to the EH-capable device based on evaluating the one or more criteria, information that is configured to update the operating status of the amplifier of the EH-capable device.

Another apparatus for wireless communication at a wireless communications device is described. The apparatus may include means for identifying one or more criteria associated with an operating status of an amplifier of an energy harvesting (EH)-capable device, where the EH-capable device is configured to transition between an energy harvesting state and an active state in accordance with an energy level of a power source associated with EH-capable device, means for evaluating the one or more criteria based on communications with the EH capable device, and means for transmitting, to the EH-capable device based on evaluating the one or more criteria, information that is configured to update the operating status of the amplifier of the EH-capable device.

A non-transitory computer-readable medium storing code for wireless communication at a wireless communications device is described. The code may include instructions executable by a processor to identify one or more criteria associated with an operating status of an amplifier of an energy harvesting (EH)-capable device, where the EH-capable device is configured to transition between an energy harvesting state and an active state in accordance with an energy level of a power source associated with EH-capable device, evaluate the one or more criteria based on communications with the EH capable device, and transmit, to the EH-capable device based on evaluating the one or more criteria, information that is configured to update the operating status of the amplifier of the EH-capable device.

In some examples of the method, apparatuses, and non-transitory computer-readable medium described herein, the information may be configured to activate or deactivate the amplifier or adjust a gain of the amplifier.

Some examples of the method, apparatuses, and non-transitory computer-readable medium described herein may further include operations, features, means, or instructions for receiving, from the EH-capable device, information indicative of the updated operating status of the amplifier.

Some examples of the method, apparatuses, and non-transitory computer-readable medium described herein may further include operations, features, means, or instructions for receiving, from the EH-capable device, information indicative of an operating condition of the EH-capable device, where the operating condition may be evaluated relative to the one or more criteria and the information may be transmitted based on the operating condition.

Some examples of the method, apparatuses, and non-transitory computer-readable medium described herein may further include operations, features, means, or instructions for evaluating the energy level of the power source associated with the EH-capable device relative to the one or more criteria, where the information may be based on the energy level.

In some examples of the method, apparatuses, and non-transitory computer-readable medium described herein, evaluating the energy level may include operations, features, means, or instructions for determining whether the energy level may be greater than an energy level threshold.

In some examples of the method, apparatuses, and non-transitory computer-readable medium described herein, the information may be configured to activate the amplifier based on the energy level being greater than the energy level threshold.

In some examples of the method, apparatuses, and non-transitory computer-readable medium described herein, the information may be configured to deactivate the amplifier based on the energy level being less than the energy level threshold.

In some examples of the method, apparatuses, and non-transitory computer-readable medium described herein, evaluating the energy level may include operations, features, means, or instructions for determining that the energy level corresponds to an energy state of a set of multiple energy states, where the updated operating status corresponds to the energy state.

In some examples of the method, apparatuses, and non-transitory computer-readable medium described herein, each energy state of the set of multiple energy states may be associated with a respective operating status of the amplifier.

In some examples of the method, apparatuses, and non-transitory computer-readable medium described herein, evaluating the energy level may include operations, features, means, or instructions for evaluating a charging rate or a discharging rate of the power source.

Some examples of the method, apparatuses, and non-transitory computer-readable medium described herein may further include operations, features, means, or instructions for evaluating a reference signal measurement relative to the one or more criteria, where the information may be configured to update the operating status based on the reference signal measurement.

In some examples of the method, apparatuses, and non-transitory computer-readable medium described herein, the reference signal measurement may be a reference signal received power, a reference signal received quality, a signal to interference and nose ratio, a reference signal pathloss, a received signal strength, or a combination thereof.

In some examples of the method, apparatuses, and non-transitory computer-readable medium described herein, the one or more criteria include one or more reference signal measurement thresholds.

In some examples of the method, apparatuses, and non-transitory computer-readable medium described herein, the one or more criteria include a delta in the reference signal measurement relative to a prior reference signal measurement.

Some examples of the method, apparatuses, and non-transitory computer-readable medium described herein may further include operations, features, means, or instructions for identifying a communication parameter for communications with a reader user equipment (UE), where the information may be configured to update the operating status based on the communication parameter.

In some examples of the method, apparatuses, and non-transitory computer-readable medium described herein, the communication parameter includes a data rate, a symbol duration, a modulation and coding scheme, a traffic priority, a reliability target, a packet error rate, or a combination thereof.

Some examples of the method, apparatuses, and non-transitory computer-readable medium described herein may further include operations, features, means, or instructions for receiving, from the EH-capable device, feedback corresponding to a communication transmitted to the EH-capable device, where the information may be configured to update the operating status based on whether the feedback may be an acknowledgment or a negative acknowledgment.

In some examples of the method, apparatuses, and non-transitory computer-readable medium described herein, evaluating the one or more criteria may include operations, features, means, or instructions for determining that a quantity of consecutive negative acknowledgments corresponding to communications transmitted to the EH-capable device satisfies a threshold quantity of negative acknowledgments, where the information may be configured to update the operating status based on the threshold quantity of negative acknowledgments being satisfied.

In some examples of the method, apparatuses, and non-transitory computer-readable medium described herein, evaluating the one or more criteria may include operations, features, means, or instructions for determining a distance between a reader UE and the EH-capable device, where the information may be configured to update the operating status based on the distance.

In some examples of the method, apparatuses, and non-transitory computer-readable medium described herein, evaluating the one or more criteria may include operations, features, means, or instructions for determining that a timer associated with a current operating status may be expired, where the information may be configured to update the operating status based on expiration of the timer.

In some examples of the method, apparatuses, and non-transitory computer-readable medium described herein, evaluating the one or more criteria may include operations, features, means, or instructions for determining a slot location or a symbol location used for communications with the EH-capable device, where the information may be configured to update the operating status based on the slot location or the symbol location.

In some examples of the method, apparatuses, and non-transitory computer-readable medium described herein, evaluating the one or more criteria may include operations, features, means, or instructions for evaluating a buffer state associated with communications with the EH-capable device, where the information may be configured to update the operating status based on the buffer state.

In some examples of the method, apparatuses, and non-transitory computer-readable medium described herein, evaluating the buffer state may include operations, features, means, or instructions for evaluating the buffer state relative to a buffer state threshold.

In some examples of the method, apparatuses, and non-transitory computer-readable medium described herein, transmitting the information may include operations, features, means, or instructions for transmitting a wake-up signal.

In some examples of the method, apparatuses, and non-transitory computer-readable medium described herein, the wireless device may be a network entity, a reader UE, a transmitter UE, or both a reader and a transmitter UE.

### BRIEF DESCRIPTION OF THE DRAWINGS

FIG. 1 shows an example of a wireless communications system that supports conditions to adjust an amplifier for energy harvesting devices in accordance with one or more aspects of the present disclosure.

FIG. 2 shows an example of a wireless communications system that supports conditions to adjust amplifier for energy harvesting devices in accordance with one or more aspects of the present disclosure.

FIG. 3 shows an example of a state and timing diagram that supports conditions to adjust an amplifier for energy harvesting devices in accordance with one or more aspects of the present disclosure.

FIGS. 4A and 4B show examples of state and timing diagrams that support conditions to adjust an amplifier for energy harvesting devices in accordance with one or more aspects of the present disclosure.

FIG. 5 shows an example of a process flow that supports conditions to adjust an amplifier for energy harvesting devices in accordance with one or more aspects of the present disclosure.

FIGS. 6 and 7 show block diagrams of devices that support conditions to adjust an amplifier for energy harvesting devices in accordance with one or more aspects of the present disclosure.

FIG. 8 shows a block diagram of a communications manager that supports conditions to adjust an amplifier for energy harvesting devices in accordance with one or more aspects of the present disclosure.

FIG. 9 shows a diagram of a system including a device that supports conditions to adjust an amplifier for energy harvesting devices in accordance with one or more aspects of the present disclosure.

FIGS. 10 and 11 show block diagrams of devices that support conditions to adjust an amplifier for energy harvesting devices in accordance with one or more aspects of the present disclosure.

FIG. 12 shows a block diagram of a communications manager that supports conditions to adjust an amplifier for energy harvesting devices in accordance with one or more aspects of the present disclosure.

FIG. 13 shows a diagram of a system including a device that supports conditions to adjust an amplifier for energy harvesting devices in accordance with one or more aspects of the present disclosure.

FIGS. 14 through 18 show flowcharts illustrating methods that support conditions to adjust an amplifier for energy harvesting devices in accordance with one or more aspects of the present disclosure.

### DETAILED DESCRIPTION

Some wireless communications systems may include passive devices, such as radio frequency identifier (RFID) tags, to perform operations such as location tracking and identification. In some cases, an RFID tag may include an active component, such as a low noise amplifier (LNA) to improve decoding reliability. Tags equipped with LNAs may consume more power than tags without LNAs. To avoid increased power consumption by the LNA, the tag may adjust the operational parameters of the LNA (e.g., the gain state of the LNA, the duration of an “on” state of the LNA). In some examples, the tag may adjust the parameters based on receiving control signaling from a reader device (henceforth referred to as a reader). Additionally, or alternatively, the tag may control the operational parameters of the LNA without receiving control signaling from a reader. However, conditions for adjusting the LNA may not be defined, and as a result, the LNA may continuously operate in an “on” state, which may result in additional power consumption at the tag.

Various aspects of the present disclosure relate to conditions to adjust an amplifier for energy harvesting devices, such as a tag. In some examples, a reader may transmit information to the tag to cause the tag to update the operating status of the amplifier based on communications with the tag satisfying at least one criterion. In other examples, an energy provider may transmit the information to the tag to cause the tag to update the operating status of the amplifier based on communications with the tag satisfying at least one criterion. In such examples, the tag may adjust the amplifier based on receiving the information from the reader or energy provider. In some other examples, the tag may adjust the amplifier based on one or more criteria evaluations. Criteria for adjusting the amplifier may include an energy state threshold of the tag, an energy state timer of the tag, a received signal strength, a received power, a battery percentage (e.g., availability of energy), a charging rate, or a discharging rate, among others. The criteria may be preconfigured or dynamically configured to the tag. Additionally, or alternatively, the conditions may be evaluated based on one or more mapping rules. Furthermore, the reader, transmitter, or the tag may adjust a timing information of the amplifier based on the condition evaluations. The timing information may include an indication of a start time of an LNA state, a stop time of an amplifier state, or a duration of an amplifier state. Additionally, or alternatively, the reader or transmitter may transmit, to the tag, an indication of an amplifier cycle (e.g., a pattern of on states and off states).

Aspects of the disclosure are initially described in the context of wireless communications systems. Aspects of the disclosure are additionally illustrated with reference to state and timing diagrams and process flows. Aspects of the disclosure are further illustrated by and described with reference to apparatus diagrams, system diagrams, and flowcharts that relate to conditions to adjust amplifier for energy harvesting devices.

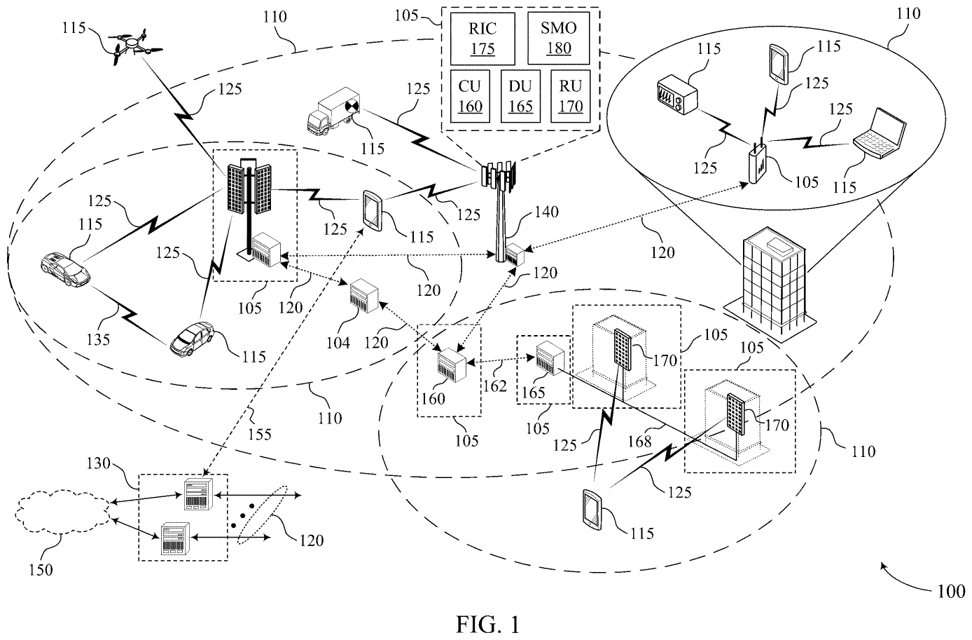

FIG. 1 shows an example of a wireless communications system 100 that supports conditions to adjust an amplifier for energy harvesting devices in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125.

The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUS 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support conditions to adjust an amplifier for energy harvesting devices as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device.

The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, the wireless communications system 100 may support or include an EH device, which may implement backscatter communications to transmit information to a reader device, such as a UE 115 or network entity 105. The EH device may be an example of a UE 115. The tag may further include an amplifier, such as a low noise amplifier (LNA), to improve decoding reliability. In some examples, an associated device (e.g., a network entity 105, a reader UE 115, a transmitter UE 115, or both a reader UE 115 and a transmitter UE 115) may adjust an operational state (e.g., a power state, a gain state) of the amplifier via information transmitted to the tag. In some other examples, the tag may adjust an operational state of the amplifier based on evaluating one or more criteria. The criteria may be preconfigured or dynamically configured to the tag. Additionally, or alternatively, the associated device may adjust the amplifier based on evaluating one or more criteria. In some examples, the tag may adjust the amplifier and/or the associated device may transmit the information to cause the amplifier operating status to be updated based on mapping rules. Furthermore, the associated device or the tag may adjust a timing information of the amplifier based on the criteria or the mapping rules. Additionally, or alternatively, the associated device may transmit, to the tag, an indication of an amplifier cycle (e.g., a discontinuous reception (DRX) cycle).

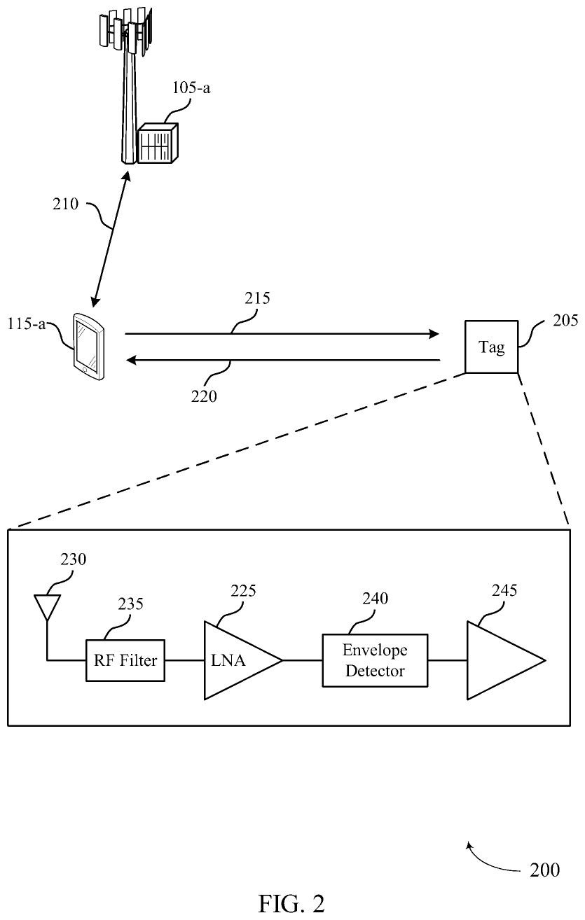

FIG. 2 shows an example of a wireless communications system 200 that supports conditions to adjust an amplifier for energy harvesting devices in accordance with one or more aspects of the present disclosure. The wireless communications system 200 may include a network entity 105-a, a UE 115-a, and a tag 205, which may be examples of corresponding devices as described herein, including with reference to FIG. 1. The network entity 105 may communicate with the UE 115-a over a cellular communication link (e.g., Uu link) 210. The UE 115-a and the tag 205 may communicate over forward link 215 and backscatter link 220.

The tag 205 may be an example of a device used for ambient IoT applications. Ambient IoT devices (e.g., passive devices, semi-passive devices, active devices) are devices which rely on passive communication technologies, such as backscatter communication techniques, to communicate information. A ultra-high frequency (UHF) RFID device is an example of a device used in these ambient IoT applications. However, some UHF RFI systems may not be compatible with some wireless communication radio access technologies (RATs), such as NR or 5G, as RFID systems may function in an ISM band, while NR systems may function in a licensed band. Additionally, these UHF RFID systems may not support energy harvesting. When energy harvesting is introduced, the tag 205 may be alternatively in an “on” or “off” state. In some cases, the tag 205 may be in the on or off state for some duration (e.g., 500 ms). When the tag 205 is on, the tag 205 may be able to maintain time and perform transmission and reception operations. When the tag 205 is off, the tag may perform energy harvesting but may not be able to maintain timing or perform transmission or reception operations.

In some examples, the tag 205 is equipped with an amplifier 225, an antenna 230, an RF filter 235, an envelope detector 240, and/or a comparator 245. The amplifier 225 may be an LNA, a power amplifier, a tunnel diode, or any combination thereof. In some cases, the amplifier 225 may consume more power than the tag integrated circuit (e.g., 30 μW versus 1 μW). The tag 205 may include the amplifier 225 (e.g., LNA) to function as a envelop detector and may implement multi-stage LNAs for better signal amplification ability. The tag 205 may adjust a state (e.g., a power state, a gain state, or both the power and gain state) of the amplifier 225. Additionally, or alternatively, a reader or energy transmitter (e.g., network entity 105-a, UE 115-a) may adjust the state of the amplifier 225 by sending control signaling to the tag 205. The tag 205 may adjust the state of the amplifier 225 based on receiving the control signaling from the reader or energy transmitter. Accordingly, techniques described herein support the tag 205 and/or the reader or transmitter (e.g., the UE 115-a) performing operations to adjust the operating status (e.g., gain or on/off state) of the tag 205.

The UE 115-a in wireless communications system 200 may be either a reader device or an energy-providing device with respect to the tag 205, or both. Additionally, it is to be understood that UE 115-a may be replaced with a network entity or other wireless communications device.

The UE 115-a or the tag 205 may determine to adjust the amplifier 225 based on evaluating one or more criteria associated with wireless communications between the UE 115-a and tag 205. The criteria may be preconfigured to the tag 205 or may be dynamically configured to the tag 205. For example, the criteria may be indicated to the tag via control signaling transmitted by the UE 115-a. The one or more criteria associated with wireless communications between the UE 115-a and tag 205 may include: an energy state of the tag 205 (e.g., an energy level of the tag 205, a charging rate, a discharging rate, an available battery percentage) and/or timers associated with the tag 205. Additionally, or alternatively, the devices may utilize, as criteria, a reference signal measurement (e.g., a reference signal received power (RSRP), a reference signal received quality (RSRQ), a signal-to-interference-plus-noise ratio (SINR), a reference signal pathloss, a received signal strength), a drop in a reference signal measurement relative to a previous reference signal measurement. Thus, if the reference signal measurement is above a threshold, then the amplifier may be adjusted to a lower or higher gain state.

The criteria may also include one or more communication parameters (e.g., a buffer state, a data rate, a data rate mode, a symbol duration, a modulation and coding scheme, a traffic priority, a reliability target, a packet error rate), the absence of acknowledgment (ACK) or non-acknowledgment (NACK) feedback messages, a quantity of continuous NACK messages, or any combination thereof. For example, if data to be communicated between the UE 115-a and the tag 205 is associated with a high priority, then the tag 205 may increase the gain of the amplifier. As another example, if the quantity of continuous NACK messages satisfies a threshold, then the tag 205 may increase the gain of the amplifier. As yet another example, if the buffer state of the UE 115-a or tag 205 is greater than a threshold, then the amplifier may be adjusted to an “on” state or the gain to the amplifier may be adjusted.

The criteria may also be based on a distance between the tag 205 and the UE 115-a. For example, if the distance between the UE 115-a and the tag 205 is larger than a threshold, then the tag 205 may configure the amplifier to be in an “on” state or may adjust the gain to the amplifier.

In some examples, the tag 205 may adjust the state of the amplifier 225 based on evaluating the one or more criteria. For example, the tag 205 may adjust a power state of the amplifier 225 by activating or deactivating the amplifier 225 or by adjusting the gain of the amplifier 225. In some cases, the tag 205 may transmit information indicating the state of the amplifier 225 to the UE 115-a, such as to report the state of the amplifier 225 the UE 115-a. This technique may allow the UE 115-a to adjust subsequent communications with the tag based on the amplifier status. In some examples, the UE 115-a may transmit an indication (e.g., explicitly or implicitly) of the one or more criteria to the tag 205, which may result in the tag 205 adjusting the amplifier based on the criteria evaluations. In some cases, the UE 115-a or the tag 205 may evaluate the one or more criteria according to mapping rules. The mapping rules may be defined by one or more threshold values, a mapping table, or any combination thereof.

In some cases, the UE 115-a or tag 205 may also determine amplifier state timing information (e.g., an amplifier state start time, an amplifier state stop time, an amplifier state duration, an amplifier state timer). The amplifier state timing information may be determined based on the one or more criteria or mapping rules. In examples when the UE 115-a may determine the amplifier state timing information, the amplifier state timing information may be indicated in command or control signaling and may be configured dynamically (e.g., L1 or L2 signaling) or semi-statically (e.g., L3 signaling) to the tag 205. In such cases, the timing information explicitly or implicitly indicated to the tag 205. In an example of an implicit indication, the UE 115-a may indicate that it may transmit signals to the tag 205 over one or more slots, symbols, or both. The tag 205 may turn on the amplifier 225 during the one or more slots, symbols, or both indicated to the tag 205 by the UE 115-a. Responsive to updating the state of the amplifier 225, the tag 205 may transmit an indication of the updated state of the amplifier 225 to the UE 115-a.

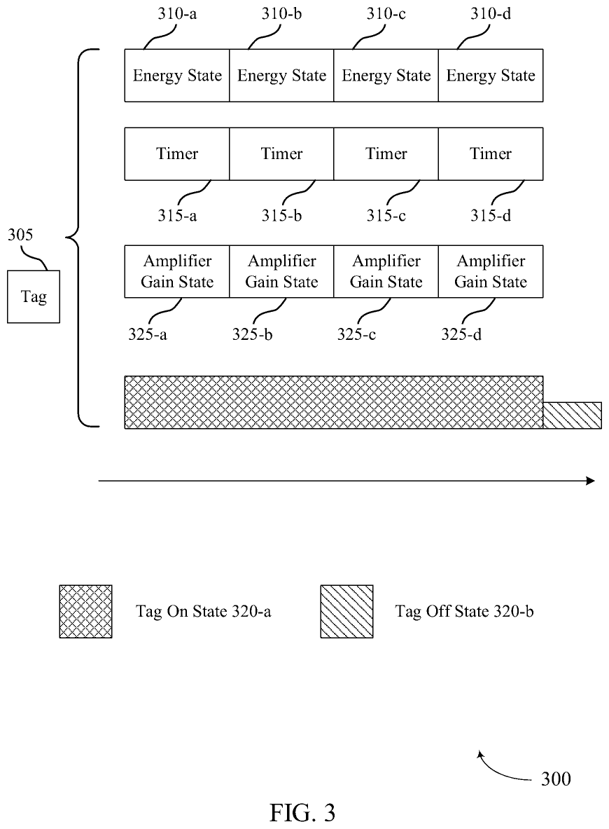

FIG. 3 shows an example of a state and timing diagram 300 that supports conditions to adjust an amplifier for energy harvesting devices in accordance with one or more aspects of the present disclosure. The state and timing diagram 300 may be implemented by aspects of the wireless communications system 100 and the wireless communications system 200 as described with reference to FIGS. 1 and 2. For instance, in the example of FIG. 3, one of the criteria for adjusting the amplifier 225 (e.g., the LNA) may be an energy state of the tag 305. The tag 305 may be associated with energy states 310, timers 315, tag power states 320, and/or amplifier gain states 325. The tag 305 may be an example of an EH capable device, as described herein.

In some cases, the tag power state 320 may be determined based on the energy states 310, the timers 315, or both. For example, if the tag has enough energy stored or harvested (e.g., above a threshold power), then the tag may be the tag power state 320-a (e.g., an “on” state). If the tag does not have enough energy stored or harvested (e.g., below the threshold power), then the tag may be in the tag power state 320 (e.g., an “off” state). In cases where the tag is in the tag power state 320-a (e.g., an “on” state), the associated device (reader or energy provider) or tag 305 may evaluate one or more criteria based on operating conditions at the tag to determine an operating status (e.g., the amplifier gain state 325) of the amplifier. In the example of FIG. 3, the associated device or tag 305 determine, for the operating condition, that an energy state 310 satisfies a threshold and may adjust the amplifier gain state 325 based on the determination. For example, the tag 305 may determine that energy states 310-a, 310-c, or both, are greater than a threshold value. Based on this comparison, the tag may adjust the amplifier gain state 325 to amplifier gain states 325-a and 325-c, respectively. The amplifier gain states 325-a and 325-c may be examples of amplifier “on” states or may correspond to gain values applied to the amplifier. In some other examples, the tag 305 may determine that energy states 310-b, 310-d, or both, are less than a threshold value. Based on this comparison, the tag may adjust the amplifier status to amplifier gain states 325-b and 325-d, respectively. The amplifier gain states 325-b and 325-c may be examples of “off” states or may correspond to gain values applied to the amplifier. Additionally, or alternatively, the tag 305 may use the timers 315 to determine the operating status of the amplifier. In some examples, the timers correspond to the tag power states 320. Thus, when the tag has the tag power state 320-a, the timers 315 may be activated, and a duration of each timer may correspond to a particular operating state of the amplifier. Thus, during timer 315-a duration, the tag applies amplifier gain state 325-a, and during timer 315-b duration, the tag 305 applies amplifier gain state 325-b. As described, the different amplifier gain states 325-a may correspond to whether the amplifier is on or off or a different gain value applied to the amplifier.

In some other cases, the amplifier gain state 325 may be determined based on one or more mapping rules. In such cases, the associated device or tag 305 may determine that an energy state 310 or timer 315 is associated with a tag operational state (e.g., a tag power state 320, an amplifier gain state 325, or both) based on the mapping rules. As illustrated, the mapping rules may indicate that that energy state 310-a or timer 315-a is associated with the amplifier gain state 325-a, energy state 310-b or timer 315-b is associated with the amplifier gain state 325-b, energy state 310-c or timer 315-c is associated with the amplifier gain state 325-c, and energy state 310-d or timer 315-d is associated with the amplifier gain state 325-d.

For example, the amplifier gain state 325-a is a 20 dB gain, the amplifier gain state 325-b is a 15 dB gain, the amplifier gain state 325-c may is 10 dB gain, and the amplifier gain state 325-d may be a 5 dB gain. Thus, based on the energy state 310-a and/or the timer 315-a, the tag 305 applies the respective gain to the amplifier. Accordingly, this technique may allow the amplifier to have a high gain for a short duration and use a low gain for a longer duration, which may support improved power consumption efficiency. Additionally, these gains and states may be used for different target communication durations with the associated device, for example, As noted, the tag 305 may evaluate the timers 315 and/or the energy states 310 to adjust the operating status of the amplifier (e.g., to determine the amplifier gain states 325). Additionally, or alternatively, the associated device may evaluate such operating conditions (e.g., the energy state and timer) and instruct the tag 305 to adjust the operating status of the amplifier based on the evaluations (and/or application of the mapping rules). In such cases, the tag 305 may report the operating conditions (e.g., energy state or timer) to the associated device, and the associated device may instruct the tag 305 to adjust the operating status based on the reporting. Additionally, or alternatively, the associated device may be configured with the energy state 310 that are based on when the tag is in the tag power state 320-a (e.g., the “on” state). Thus, when the tag 305 is on, the associated device may adjust the operating status of the amplifier of the tag 305 based on predicted energy states relative to when the tag is in the “on” state.

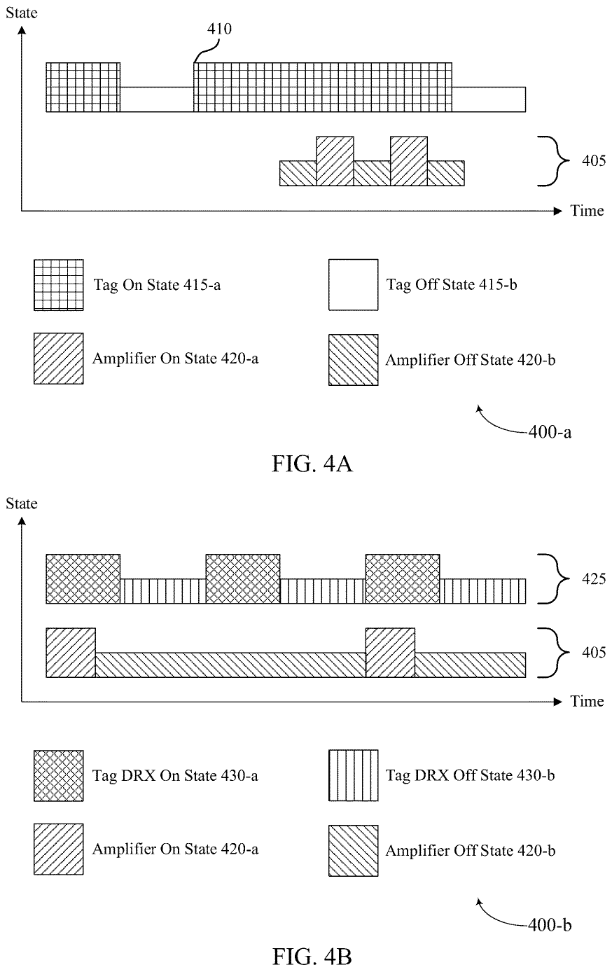

FIGS. 4A and 4B show example state and timing diagrams 400-a and 400-b that support conditions to adjust an amplifier for energy harvesting devices in accordance with one or more aspects of the present disclosure. The state and timing diagrams 400 may be implemented by aspects of the wireless communications system 100 and the wireless communications system 200 as described with reference to FIGS. 1 and 2. For instance, in the example of FIG. 4A, the associated device or tag (e.g., an EH-capable device) may determine tag amplifier state timing information in accordance with aspects of the present disclosure.

In addition to determining timing information (e.g., amplifier state start time, amplifier state stop time, amplifier state duration), the associated device may configure the tag with an amplifier cycle 405. For example, at 410, the tag may transition to an on state 415-a from an off state 415-b based on receiving a wakeup signal (e.g., WUS) from the associated device. While in the on state 415-a, the tag may transmit an indication of the tag energy state (e.g., energy level, whether the energy level is above a threshold) to the associated device. Based on receiving this indication, the associated device may configure the tag with an amplifier cycle 405. The amplifier cycle 405 may be comprised of a pattern of one or more amplifier on states 420-a and amplifier off states 420-b. The amplifier cycle 405 may be determined based on the one or more criteria or mapping tables as described herein. In some examples, the tag may determine the amplifier cycle 405 and report the cycle (e.g., states and durations) to the associated device so that the associated device may determine communications with the tag.

In some cases, the tag may operate according to an on/off pattern (e.g., a discontinuous reception (DRX) cycle). In the tag off state, the tag may not be able to receive signals but may be able to maintain timing information. In the tag on state, the tag may receive signals. For example, the tag may be configured with a connected-mode discontinuous reception (C-DRX) cycle, an idle-mode discontinuous reception (I-DRX) cycle, or both. In such cases, the operating status of the amplifier may be configured based on the tag DRX cycle. FIG. 4B illustrates an example of a tag configured with a DRX cycle 425 and an associated amplifier cycle 405. The DRX cycle 425 may be comprised of one or more on states 430-a and off states 430-b. The amplifier cycle 405 may be comprised of one or more amplifier on states 420-a and amplifier off states 420-b. The amplifier cycle 405 and the DRX cycle 425 may share cycles, configurations, or both. Additionally, the amplifier cycle 405 and DRX cycle 425 may partially overlap or fully overlap in time. The tag may have an amplifier cycle 405 for C-DRX operations and an amplifier cycle 405 for I-DRX operations. In some cases, the amplifier cycle for C-DRX operations and the amplifier cycle for I-DRX operations may be the same cycle.

In some cases, the reader may transmit a control signal (e.g., a WUS, a paging indication, L1/L2/L3 signaling) to the tag. The tag may monitor for the control signaling to adjust the state of the amplifier (e.g., adjust a power state of the amplifier, adjust a gain state for automatic gain control (AGC)). For example, the tag may receive a WUS from the reader. The WUS may indicate to the tag to transition into a DRX on state 430-a or a DRX off state 430-b. Additionally, the WUS may indicate to the tag an amplifier cycle 405 and a duration of an amplifier on state 420-a. The duration of the amplifier on state 420-a may comprise a portion or all of a DRX on state 430-a. The reader or tag may further adjust the power state, gain state, or both the power and gain state of the amplifier on state 420-a. Furthermore, in accordance with aspects of the present disclosure, the amplifier on state 420-a may further comprise additional amplifier on states 420-a, which may have different power states, gain states, or both. The tag may adjust an amplifier cycle 405 based on receiving a WUS or a paging indication for a DRX cycle 425 not associated with the current amplifier cycle 405.

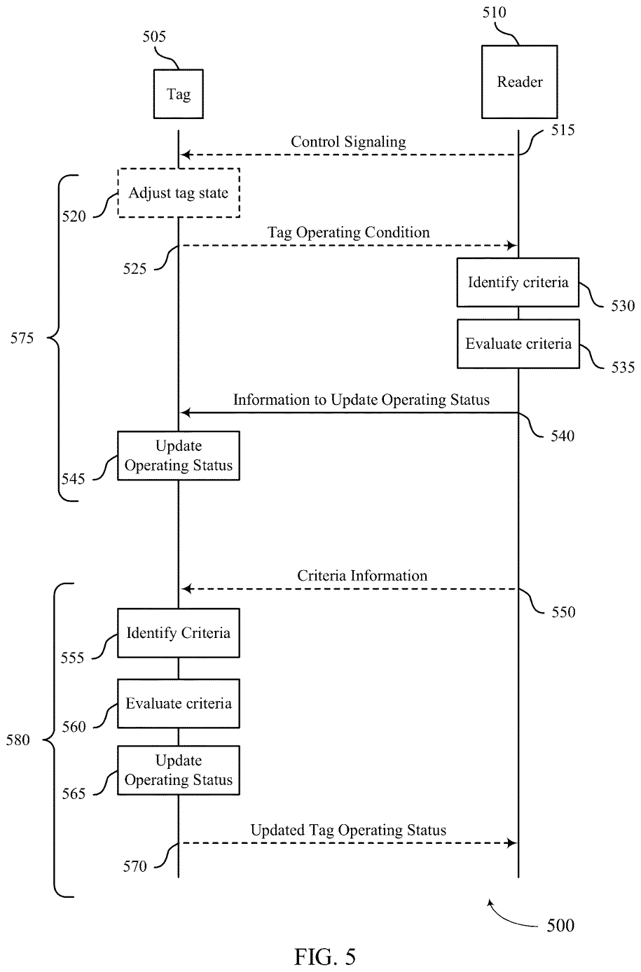

FIG. 5 shows an example of a process flow 500 that supports conditions to adjust an amplifier for energy harvesting devices in accordance with one or more aspects of the present disclosure. The process flow 500 may implement or may be implemented by aspects of the wireless communications system 100 and the wireless communications system 200 as described with reference to FIGS. 1 and 2. For instance, in the example of FIG. 5, a tag 505 and reader 510 may be in communication with each other as described with reference to FIGS. 1 and 2. The reader 510 may be an example of a network entity or a UE as described with reference to FIGS. 1 and 2, and the tag 505 may be an example of an EH-capable device, as described herein. The reader 510 could also be an energy providing device. The tag 505 and reader 510 may communicate via respective communication links, which may be examples of communication links 210, forward links 215, and backscatter links 220 as described with reference to FIG. 2. In the following description of the process flow 500, the operations between the tag 505 and reader 510 may be transmitted in a different order than the example order shown, or the operations between the tag 505 and reader 510 may be performed in different orders or at different times. Some operations may also be omitted from the process flow 500, and other operations may be added to the process flow 500.

The operations at 575 are example operations for the reader 510 evaluating conditions and instructing the tag 505 to update the operating status of the amplifier. At 515, the reader 510 sends control signaling to the tag 505. As described herein, the control signaling may be a WUS, a paging indication, or L1/L2/L3 signaling.

At 520, the tag 505 may adjust the state of the tag 505. For example, the tag 505 may transition from an on state to an off state, or vice-versa. The tag 505 may adjust the state of the tag 505 based on receiving the control signaling from the reader 510.

At 525, the tag 505 may send an indication of a current tag operating condition to the reader 510. The indication of a current tag operating condition may include an indication of the one or more criteria associated with wireless communications as described herein. For example, the tag 505 may send an indication of a current energy state of the tag 505 to the reader 510. Additionally, or alternatively, the indication may include feedback corresponding to a communication transmitted from the reader 510. Additionally, or alternatively, the indication of the operating condition may include information such as reference signal measurements, change in reference signal measurements, timer statuses, computing parameters (e.g., data rate, symbol duration, modulating and coding scheme, traffic priority, reliability target, a packet error rate), and a buffer state.

At 530, the reader 510 may identify one or more criteria associated with the operating status of an amplifier of an energy harvesting (EH)-capable device (e.g., the tag 505). The EH-capable device is configured to transition between an energy harvesting state and an active state in accordance with an energy level of a power source associated with EH-capable device. Identification of the one or more criteria may include receiving an indication of the criteria from a network entity, the tag, or both. The one or more criteria may be configured at the reader 510.

At 535, the reader 510 may evaluate one or more criteria based on communications with the EH-capable device. For example, the communications may include the indications of the current tag operating conditions received from the tag. In some examples, the reader 510 may determine that an energy state of the tag 505 is greater than the threshold value or less than a threshold value. In some other cases, the reader 510 may further determine that an energy level associated with the tag 505 may correspond to a state of the amplifier according to mapping rules. In some examples, evaluating the energy level may include evaluating a charging rate or discharging rate of the power source (e.g., battery) of the amplifier. In some other cases, the reader 510 may determine that a timer associated with an energy state of the tag has expired. Additionally, or alternatively, the reader 510 may evaluate a reference signal measurement (e.g., an RSRP, RSRQ, SINR a reference signal pathloss, a received signal strength). In such cases, the tag 505 may evaluate the reference signal measurement relative to a threshold or to a previous reference signal measurement. The reference signal measurements may be measurements performed by the reader 510 and/or the tag 505, and the reference signals may be transmitted by the reader 510 and/or the tag 505. Further, the tag 505 may also evaluate a communication parameter (e.g., a buffer state, a data rate, a data rate mode, a symbol duration, a modulation and coding scheme, a traffic priority, a reliability target, a packet error rate), a quantity of consecutive NACK messages, a distance between the tag 505 and reader 510, or any combination thereof. In some cases, the reader 510 may evaluate the one or more criteria associated with the tag 505 according to mapping rules.

At 540, the reader 510 transmits, to the tag 505 (e.g., the EH-capable device), based on evaluating the one or more criteria, information that is configured to update the operating status of the amplifier of the EH-capable device. The information may include timing information, an amplifier state, or both. For example, the information may include an indication of one or more times for updating the amplifier of the tag 505. In some cases, the indication may be a start time for an amplifier state, a stop time for an amplifier state, a duration of an amplifier state, or any combination thereof. In some other cases, the indication may be a location of slots or symbols for the tag 505 to monitor for information from the reader 510, such that the tag 505 may adjust the operating status of the amplifier accordingly.

At 545, the tag 505 may update the operating status of the amplifier in accordance with the received information. Updating the operating status may include activating or deactivating the amplifier or adjusting a gain of the amplifier.

Operations at 580 include operations for the tag 505 evaluating the conditions and adjusting the operating status of the amplifiers. At 550, the tag 505 may receive, from the reader 510, information indicative of one or more criteria. The information may be received via control signaling.

At 555, the tag 505 may identify one or more criteria associated with an operating status of an amplifier of the EH-capable device (e.g., the tag 505). In some cases, the tag 505 identifies the criteria based on the received information.

At 560, the tag 505 may evaluate one or more criteria associated with an amplifier status. The tag 505 may evaluate the criteria based on receiving the information from the reader 510. In some cases, the tag 505 may evaluate an energy state (e.g., an energy level, a charging rate, a discharging rate, an available battery percentage) of the tag 505. In some cases, the tag 505 may evaluate the energy state relative to a threshold value. For example, the tag 505 may determine that an energy state of the tag 505 is greater than the threshold value or less than a threshold value. In some other cases, the tag 505 may further determine that an energy level associated with the tag 505 may correspond to a state of the amplifier according to mapping rules. Evaluating the energy level may include evaluating a charging rate or discharging rate of a power source (e.g., battery) of the tag 505. In some other cases, the tag 505 may determine that a timer associated with an energy state of the tag 505 has expired. Additionally, or alternatively, the tag 505 may evaluate a reference signal measurement (e.g., an RSRP, RSRQ, SINR a reference signal pathloss, a received signal strength). In such cases, the tag 505 may evaluate the reference signal measurement relative to a threshold or to a previous reference signal measurement. Further, the tag 505 may also evaluate a communication parameter (e.g., a buffer state, a data rate, a data rate mode, a symbol duration, a modulation and coding scheme, a traffic priority, a reliability target, a packet error rate), a quantity of consecutive NACK messages, a distance between the tag 505 and reader 510, or any combination thereof. In some other cases, if the tag 505 is equipped to support DRX operations, the tag 505 may evaluate a current status of a DRX cycle associated with the tag 505.

At 565, the tag 505 may update the operating status of the amplifier the amplifier in accordance with the operating condition and the evaluation of the one or more criteria. In some cases, the tag 505 may adjust the state (e.g., gain state, on/off state) of the amplifier based on evaluating the one or more criteria as described herein. based on determining that an energy state of the tag 505 satisfies a threshold. For example, the tag 505 may determine to turn on the amplifier based on an energy state exceeding a threshold and may determine to turn off the amplifier based on an energy state failing to exceed a threshold. In some other examples, the tag 505 may adjust the state of the amplifier based on determining that a reference signal measurement, a communication parameter, a quantity of consecutive NACK messages, a distance between the tag 505 and the reader 510, or any combination thereof, satisfies a threshold. Additionally, or alternatively, the tag 505 may adjust the state of the amplifier based on a DRX cycle associated with the tag 505. In some other cases, the tag 505 may adjust the state of the amplifier based on receiving the indication of an amplifier configuration at 535.

At 570, the tag 505 sends an indication (e.g., report) of an updated operating status of the amplifier to the reader 510. The indication may include the gain of the amplifier or the power state of the amplifier.

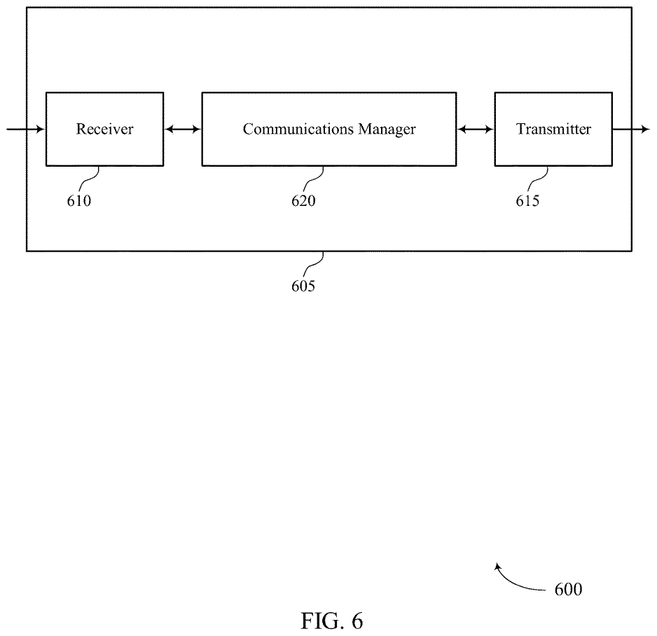

FIG. 6 shows a block diagram 600 of a device 605 that supports conditions to adjust an amplifier for energy harvesting devices in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to conditions to adjust an amplifier for energy harvesting devices). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to conditions to adjust an amplifier for energy harvesting devices). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of conditions to adjust an amplifier for energy harvesting devices as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at an energy harvesting (EH)-capable device in accordance with examples as disclosed herein. For example, the communications manager 620 may be configured as or otherwise support a means for identifying one or more criteria associated with an operating status of an amplifier of the EH-capable device, where the EH-capable device is configured to transition between an energy harvesting state and an active state in accordance with an energy level of a power source associated with the EH-capable device. The communications manager 620 may be configured as or otherwise support a means for evaluating the one or more criteria based on an operating condition at the EH-capable device. The communications manager 620 may be configured as or otherwise support a means for updating the operating status of the amplifier in accordance with the operating condition and the evaluation of the one or more criteria.

Additionally, or alternatively, the communications manager 620 may support wireless communication at a wireless communications device in accordance with examples as disclosed herein. For example, the communications manager 620 may be configured as or otherwise support a means for identifying one or more criteria associated with an operating status of an amplifier of an energy harvesting (EH)-capable device, where the EH-capable device is configured to transition between an energy harvesting state and an active state in accordance with an energy level of a power source associated with EH-capable device. The communications manager 620 may be configured as or otherwise support a means for evaluating the one or more criteria based on communications with the EH capable device. The communications manager 620 may be configured as or otherwise support a means for transmitting, to the EH-capable device based on evaluating the one or more criteria, information that is configured to update the operating status of the amplifier of the EH-capable device.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for reduced power consumption at the EH-capable device.

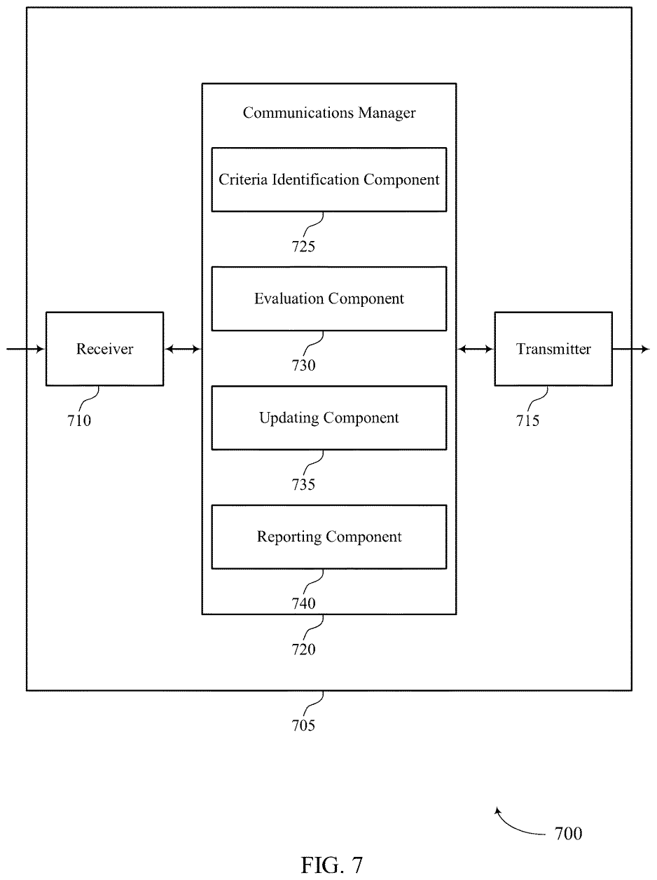

FIG. 7 shows a block diagram 700 of a device 705 that supports conditions to adjust an amplifier for energy harvesting devices in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to conditions to adjust an amplifier for energy harvesting devices). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to conditions to adjust an amplifier for energy harvesting devices). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of conditions to adjust an amplifier for energy harvesting devices as described herein. For example, the communications manager 720 may include a criteria identification component 725, an evaluation component 730, an updating component 735, a reporting component 740, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at an energy harvesting (EH)-capable device in accordance with examples as disclosed herein. The criteria identification component 725 may be configured as or otherwise support a means for identifying one or more criteria associated with an operating status of an amplifier of the EH-capable device, where the EH-capable device is configured to transition between an energy harvesting state and an active state in accordance with an energy level of a power source associated with the EH-capable device. The evaluation component 730 may be configured as or otherwise support a means for evaluating the one or more criteria based on an operating condition at the EH-capable device. The updating component 735 may be configured as or otherwise support a means for updating the operating status of the amplifier in accordance with the operating condition and the evaluation of the one or more criteria.

Additionally, or alternatively, the communications manager 720 may support wireless communication at a wireless communications device in accordance with examples as disclosed herein. The criteria identification component 725 may be configured as or otherwise support a means for identifying one or more criteria associated with an operating status of an amplifier of an energy harvesting (EH)-capable device, where the EH-capable device is configured to transition between an energy harvesting state and an active state in accordance with an energy level of a power source associated with EH-capable device. The evaluation component 730 may be configured as or otherwise support a means for evaluating the one or more criteria based on communications with the EH capable device. The reporting component 740 may be configured as or otherwise support a means for transmitting, to the EH-capable device based on evaluating the one or more criteria, information that is configured to update the operating status of the amplifier of the EH-capable device.

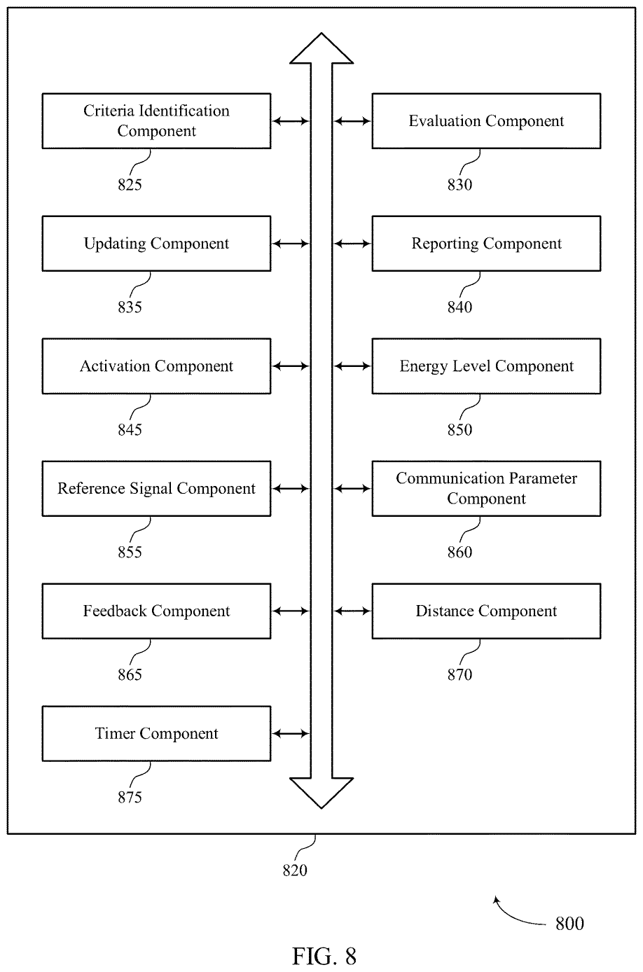

FIG. 8 shows a block diagram 800 of a communications manager 820 that supports conditions to adjust an amplifier for energy harvesting devices in accordance with one or more aspects of the present disclosure. The communications manager 820 may be an example of aspects of a communications manager 620, a communications manager 720, or both, as described herein. The communications manager 820, or various components thereof, may be an example of means for performing various aspects of conditions to adjust an amplifier for energy harvesting devices as described herein. For example, the communications manager 820 may include a criteria identification component 825, an evaluation component 830, an updating component 835, a reporting component 840, an activation component 845, an energy level component 850, a reference signal component 855, a communication parameter component 860, a feedback component 865, a distance component 870, a timer component 875, or any combination thereof. Each of these components may communicate, directly or indirectly, with one another (e.g., via one or more buses).

The communications manager 820 may support wireless communications at an energy harvesting (EH)-capable device in accordance with examples as disclosed herein. The criteria identification component 825 may be configured as or otherwise support a means for identifying one or more criteria associated with an operating status of an amplifier of the EH-capable device, where the EH-capable device is configured to transition between an energy harvesting state and an active state in accordance with an energy level of a power source associated with the EH-capable device. The evaluation component 830 may be configured as or otherwise support a means for evaluating the one or more criteria based on an operating condition at the EH-capable device. The updating component 835 may be configured as or otherwise support a means for updating the operating status of the amplifier in accordance with the operating condition and the evaluation of the one or more criteria.

In some examples, the reporting component 840 may be configured as or otherwise support a means for transmitting, to a wireless communication device, information indicative of the updated operating status of the amplifier.

In some examples, to support identifying the one or more criteria, the criteria identification component 825 may be configured as or otherwise support a means for receiving, from a wireless communication device, information indicative of the one or more criteria, where the one or more criteria are evaluated based on receiving the information.

In some examples, to support updating the operating status of the amplifier, the updating component 835 may be configured as or otherwise support a means for adjusting a gain of the amplifier based on evaluating the one or more criteria.

In some examples, the activation component 845 may be configured as or otherwise support a means for activating or deactivating the amplifier based on evaluating the one or more criteria.

In some examples, to support evaluating the one or more criteria, the energy level component 850 may be configured as or otherwise support a means for evaluating, as the operating condition, the energy level of the power source relative to the one or more criteria, where the operating status is updated based on the energy level.

In some examples, to support evaluating the energy level, the energy level component 850 may be configured as or otherwise support a means for determining whether the energy level is greater than an energy level threshold.

In some examples, to support updating the operating status of the amplifier, the activation component 845 may be configured as or otherwise support a means for activating the amplifier based on determining that the energy level is greater than the energy level threshold.

In some examples, to support updating the operating status of the amplifier, the activation component 845 may be configured as or otherwise support a means for deactivating the amplifier based on determining that the energy level is less than the energy level threshold.

In some examples, the energy level component 850 may be configured as or otherwise support a means for determining that the energy level corresponds to an energy state of a set of multiple energy states, where the updated operating status corresponds to the energy state.

In some examples, each energy state of the set of multiple energy states is associated with a respective operating status of the amplifier.

In some examples, to support evaluating the energy level, the energy level component 850 may be configured as or otherwise support a means for evaluating a charging rate or a discharging rate of the power source.

In some examples, the power source is a battery.

In some examples, to support evaluating the one or more criteria, the reference signal component 855 may be configured as or otherwise support a means for evaluating, as the operating condition, a reference signal measurement relative to the one or more criteria, where the operating status is updated based on the reference signal measurement.

In some examples, the reference signal measurement is a reference signal received power, a reference signal received quality, a signal to interference and nose ratio, a reference signal pathloss, a received signal strength, or a combination thereof.

In some examples, the one or more criteria include one or more reference signal measurement thresholds.

In some examples, the one or more criteria include a delta in the reference signal measurement relative to a prior reference signal measurement.

In some examples, the communication parameter component 860 may be configured as or otherwise support a means for identifying, as the operating condition, a communication parameter for communications with a wireless communication device, where the operating status is updated based on the identified communication parameter.

In some examples, the communication parameter includes a data rate, a symbol duration, a modulation and coding scheme, a traffic priority, a reliability target, a packet error rate, or a combination thereof.

In some examples, the feedback component 865 may be configured as or otherwise support a means for transmitting, to a wireless communication device, feedback corresponding to a communication received from the wireless communication device, where the operating status is updated based on whether the feedback is an acknowledgment or a negative acknowledgment.

In some examples, to support evaluating the one or more criteria, the feedback component 865 may be configured as or otherwise support a means for determining that a quantity of consecutive negative acknowledgments corresponding to communications received from a wireless communication device satisfies a threshold quantity of negative acknowledgments, where the operating status is updated based on the threshold quantity of negative acknowledgments being satisfied.

In some examples, to support evaluating the one or more criteria, the distance component 870 may be configured as or otherwise support a means for determining, as the operating condition, a distance between the EH-capable device and a wireless communication device, where the operating status is updated based on the distance.

In some examples, to support evaluating the one or more criteria, the timer component 875 may be configured as or otherwise support a means for determining that a timer associated with a current operating status is expired, where the operating condition is updated based on expiration of the timer.

In some examples, the criteria identification component 825 may be configured as or otherwise support a means for receiving, from a wireless communication device, information indicating one or more times for adjusting the operating condition for the amplifier, where the operating condition is updated based on the one or more times.

In some examples, to support receiving the information indicating the one or more times, the criteria identification component 825 may be configured as or otherwise support a means for receiving layer 1 signaling, layer 2 signaling, layer 3 signaling, or a combination thereof.

In some examples, the information indicates the one or more times using one or more timers, as one or more slots or symbols, cycle conditions, or a combination thereof.

In some examples, to support evaluating the one or more criteria, the evaluation component 830 may be configured as or otherwise support a means for evaluating, as the operating condition, a current status of a discontinuous reception cycle associated with the EH-capable device, where the operating status is updated based on the current status of the discontinuous reception cycle.

In some examples, to support evaluating the one or more criteria, the criteria identification component 825 may be configured as or otherwise support a means for receiving, from a wireless communication device and as the operating condition, a wake up signal, where the operating status is updated based on receiving the wake up signal.

In some examples, the amplifier is a low-noise amplifier, a power amplifier, a tunnel diode, or a combination thereof.

Additionally, or alternatively, the communications manager 820 may support wireless communication at a wireless communications device in accordance with examples as disclosed herein. In some examples, the criteria identification component 825 may be configured as or otherwise support a means for identifying one or more criteria associated with an operating status of an amplifier of an energy harvesting (EH)-capable device, where the EH-capable device is configured to transition between an energy harvesting state and an active state in accordance with an energy level of a power source associated with EH-capable device. In some examples, the evaluation component 830 may be configured as or otherwise support a means for evaluating the one or more criteria based on communications with the EH capable device. The reporting component 840 may be configured as or otherwise support a means for transmitting, to the EH-capable device based on evaluating the one or more criteria, information that is configured to update the operating status of the amplifier of the EH-capable device.

In some examples, the information is configured to activate or deactivate the amplifier or adjust a gain of the amplifier.

In some examples, the criteria identification component 825 may be configured as or otherwise support a means for receiving, from the EH-capable device, information indicative of the updated operating status of the amplifier.

In some examples, the criteria identification component 825 may be configured as or otherwise support a means for receiving, from the EH-capable device, information indicative of an operating condition of the EH-capable device, where the operating condition is evaluated relative to the one or more criteria and the information is transmitted based on the operating condition.

In some examples, the energy level component 850 may be configured as or otherwise support a means for evaluating the energy level of the power source associated with the EH-capable device relative to the one or more criteria, where the information is based on the energy level.

In some examples, to support evaluating the energy level, the energy level component 850 may be configured as or otherwise support a means for determining whether the energy level is greater than an energy level threshold.

In some examples, the information is configured to activate the amplifier based on the energy level being greater than the energy level threshold.

In some examples, the information is configured to deactivate the amplifier based on the energy level being less than the energy level threshold.

In some examples, to support evaluating the energy level, the energy level component 850 may be configured as or otherwise support a means for determining that the energy level corresponds to an energy state of a set of multiple energy states, where the updated operating status corresponds to the energy state.

In some examples, each energy state of the set of multiple energy states is associated with a respective operating status of the amplifier.

In some examples, to support evaluating the energy level, the energy level component 850 may be configured as or otherwise support a means for evaluating a charging rate or a discharging rate of the power source.

In some examples, the reference signal component 855 may be configured as or otherwise support a means for evaluating a reference signal measurement relative to the one or more criteria, where the information is configured to update the operating status based on the reference signal measurement.

In some examples, the reference signal measurement is a reference signal received power, a reference signal received quality, a signal to interference and nose ratio, a reference signal pathloss, a received signal strength, or a combination thereof.

In some examples, the one or more criteria include one or more reference signal measurement thresholds.

In some examples, the one or more criteria include a delta in the reference signal measurement relative to a prior reference signal measurement.

In some examples, the communication parameter component 860 may be configured as or otherwise support a means for identifying a communication parameter for communications with a reader UE, where the information is configured to update the operating status based on the communication parameter.

In some examples, the communication parameter includes a data rate, a symbol duration, a modulation and coding scheme, a traffic priority, a reliability target, a packet error rate, or a combination thereof.

In some examples, the feedback component 865 may be configured as or otherwise support a means for receiving, from the EH-capable device, feedback corresponding to a communication transmitted to the EH-capable device, where the information is configured to update the operating status based on whether the feedback is an acknowledgment or a negative acknowledgment.

In some examples, to support evaluating the one or more criteria, the feedback component 865 may be configured as or otherwise support a means for determining that a quantity of consecutive negative acknowledgments corresponding to communications transmitted to the EH-capable device satisfies a threshold quantity of negative acknowledgments, where the information is configured to update the operating status based on the threshold quantity of negative acknowledgments being satisfied.

In some examples, to support evaluating the one or more criteria, the distance component 870 may be configured as or otherwise support a means for determining a distance between the reader UE and the EH-capable device, where the information is configured to update the operating status based on the distance.

In some examples, to support evaluating the one or more criteria, the timer component 875 may be configured as or otherwise support a means for determining that a timer associated with a current operating status is expired, where the information is configured to update the operating status based on expiration of the timer.

In some examples, to support evaluating the one or more criteria, the criteria identification component 825 may be configured as or otherwise support a means for determining a slot location or a symbol location used for communications with the EH-capable device, where the information is configured to update the operating status based on the slot location or the symbol location.

In some examples, to support evaluating the one or more criteria, the evaluation component 830 may be configured as or otherwise support a means for evaluating a buffer state associated with communications with the EH-capable device, where the information is configured to update the operating status based on the buffer state.

In some examples, to support evaluating the buffer state, the evaluation component 830 may be configured as or otherwise support a means for evaluating the buffer state relative to a buffer state threshold.

In some examples, to support transmitting the information, the reporting component 840 may be configured as or otherwise support a means for transmitting a wake-up signal.

In some examples, the wireless device is a network entity, a reader UE, a transmitter UE, or both a reader and a transmitter UE.

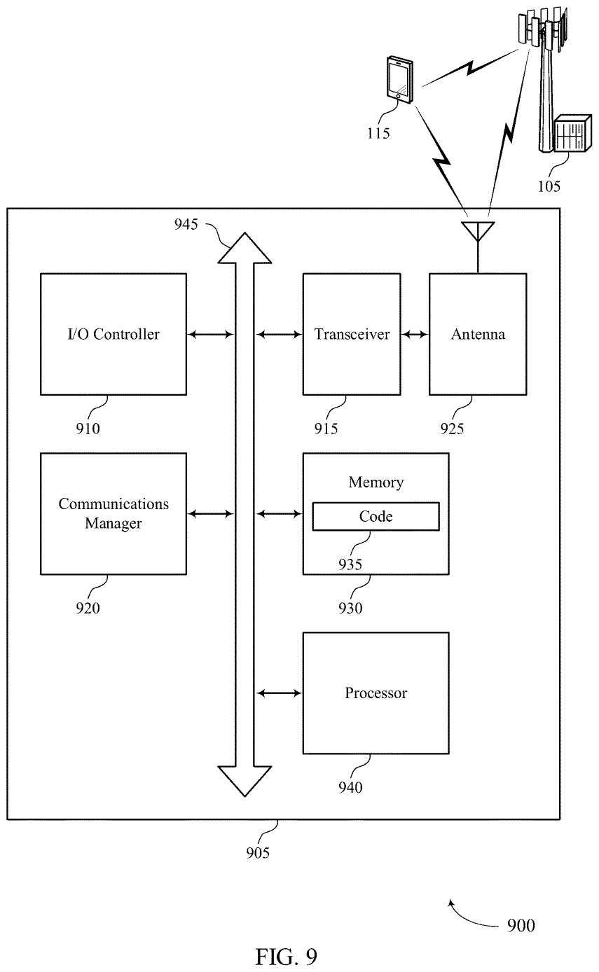

FIG. 9 shows a diagram of a system 900 including a device 905 that supports conditions to adjust an amplifier for energy harvesting devices in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting conditions to adjust an amplifier for energy harvesting devices). For example, the device 905 or a component of the device 905 may include a processor 940 and memory 930 coupled with or to the processor 940, the processor 940 and memory 930 configured to perform various functions described herein.

The communications manager 920 may support wireless communications at an energy harvesting (EH)-capable device in accordance with examples as disclosed herein. For example, the communications manager 920 may be configured as or otherwise support a means for identifying one or more criteria associated with an operating status of an amplifier of the EH-capable device, where the EH-capable device is configured to transition between an energy harvesting state and an active state in accordance with an energy level of a power source associated with the EH-capable device. The communications manager 920 may be configured as or otherwise support a means for evaluating the one or more criteria based on an operating condition at the EH-capable device. The communications manager 920 may be configured as or otherwise support a means for updating the operating status of the amplifier in accordance with the operating condition and the evaluation of the one or more criteria.

Additionally, or alternatively, the communications manager 920 may support wireless communication at a wireless communications device in accordance with examples as disclosed herein. For example, the communications manager 920 may be configured as or otherwise support a means for identifying one or more criteria associated with an operating status of an amplifier of an energy harvesting (EH)-capable device, where the EH-capable device is configured to transition between an energy harvesting state and an active state in accordance with an energy level of a power source associated with EH-capable device. The communications manager 920 may be configured as or otherwise support a means for evaluating the one or more criteria based on communications with the EH capable device. The communications manager 920 may be configured as or otherwise support a means for transmitting, to the EH-capable device based on evaluating the one or more criteria, information that is configured to update the operating status of the amplifier of the EH-capable device.

By including or configuring the communications manager 920 in accordance with examples as described herein, the device 905 may support techniques for improved communication reliability and power consumption at the EH-capable device.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of conditions to adjust an amplifier for energy harvesting devices as described herein, or the processor 940 and the memory 930 may be otherwise configured to perform or support such operations.

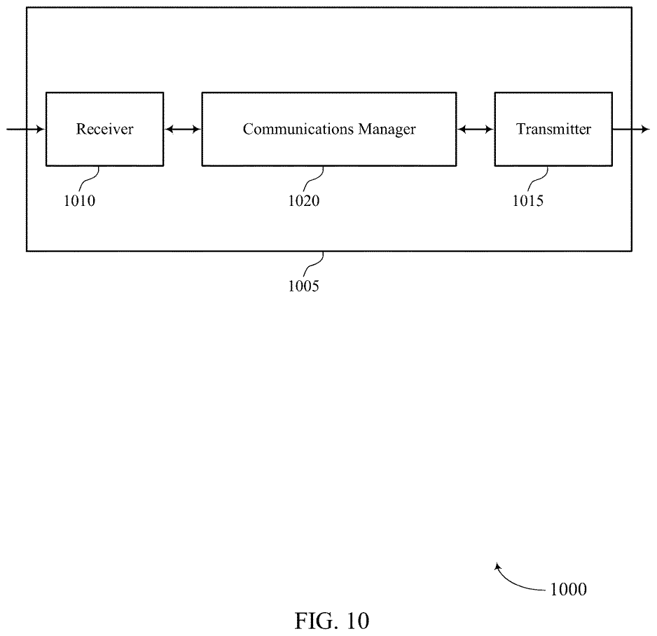

FIG. 10 shows a block diagram 1000 of a device 1005 that supports conditions to adjust an amplifier for energy harvesting devices in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of conditions to adjust an amplifier for energy harvesting devices as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a wireless communications device in accordance with examples as disclosed herein. For example, the communications manager 1020 may be configured as or otherwise support a means for identifying one or more criteria associated with an operating status of an amplifier of an energy harvesting (EH)-capable device, where the EH-capable device is configured to transition between an energy harvesting state and an active state in accordance with an energy level of a power source associated with EH-capable device. The communications manager 1020 may be configured as or otherwise support a means for evaluating the one or more criteria based on communications with the EH capable device. The communications manager 1020 may be configured as or otherwise support a means for transmitting, to the EH-capable device based on evaluating the one or more criteria, information that is configured to update the operating status of the amplifier of the EH-capable device.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for reduced power consumption at the EH-capable device.

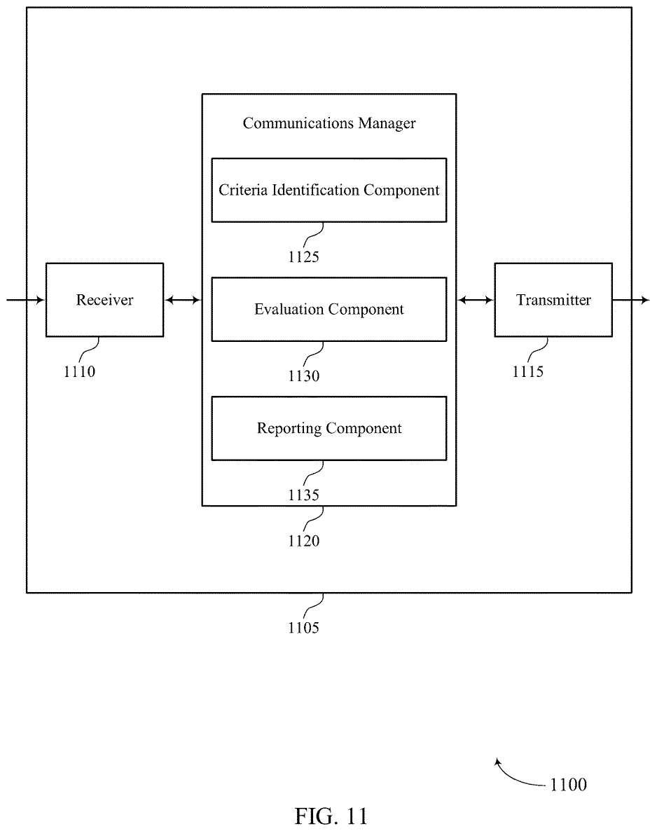

FIG. 11 shows a block diagram 1100 of a device 1105 that supports conditions to adjust an amplifier for energy harvesting devices in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of conditions to adjust an amplifier for energy harvesting devices as described herein. For example, the communications manager 1120 may include a criteria identification component 1125, an evaluation component 1130, a reporting component 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a wireless communications device in accordance with examples as disclosed herein. The criteria identification component 1125 may be configured as or otherwise support a means for identifying one or more criteria associated with an operating status of an amplifier of an energy harvesting (EH)-capable device, where the EH-capable device is configured to transition between an energy harvesting state and an active state in accordance with an energy level of a power source associated with EH-capable device. The evaluation component 1130 may be configured as or otherwise support a means for evaluating the one or more criteria based on communications with the EH capable device. The reporting component 1135 may be configured as or otherwise support a means for transmitting, to the EH-capable device based on evaluating the one or more criteria, information that is configured to update the operating status of the amplifier of the EH-capable device.

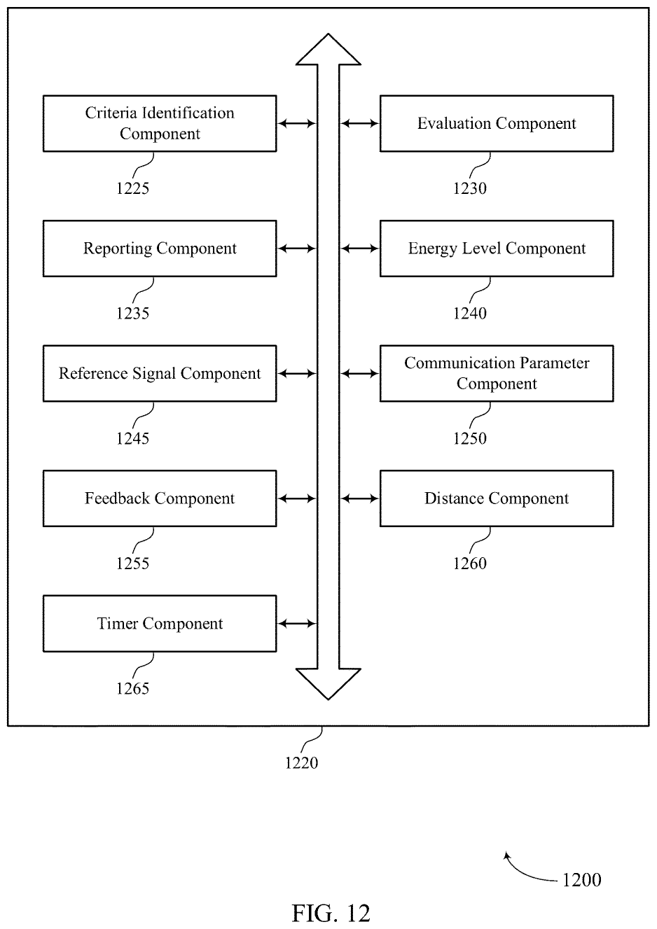

FIG. 12 shows a block diagram 1200 of a communications manager 1220 that supports conditions to adjust an amplifier for energy harvesting devices in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of conditions to adjust an amplifier for energy harvesting devices as described herein. For example, the communications manager 1220 may include a criteria identification component 1225, an evaluation component 1230, a reporting component 1235, an energy level component 1240, a reference signal component 1245, a communication parameter component 1250, a feedback component 1255, a distance component 1260, a timer component 1265, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication at a wireless communications device in accordance with examples as disclosed herein. The criteria identification component 1225 may be configured as or otherwise support a means for identifying one or more criteria associated with an operating status of an amplifier of an energy harvesting (EH)-capable device, where the EH-capable device is configured to transition between an energy harvesting state and an active state in accordance with an energy level of a power source associated with EH-capable device. The evaluation component 1230 may be configured as or otherwise support a means for evaluating the one or more criteria based on communications with the EH capable device. The reporting component 1235 may be configured as or otherwise support a means for transmitting, to the EH-capable device based on evaluating the one or more criteria, information that is configured to update the operating status of the amplifier of the EH-capable device.

In some examples, the information is configured to activate or deactivate the amplifier or adjust a gain of the amplifier.

In some examples, the criteria identification component 1225 may be configured as or otherwise support a means for receiving, from the EH-capable device, information indicative of the updated operating status of the amplifier.

In some examples, the criteria identification component 1225 may be configured as or otherwise support a means for receiving, from the EH-capable device, information indicative of an operating condition of the EH-capable device, where the operating condition is evaluated relative to the one or more criteria and the information is transmitted based on the operating condition.

In some examples, the energy level component 1240 may be configured as or otherwise support a means for evaluating the energy level of the power source associated with the EH-capable device relative to the one or more criteria, where the information is based on the energy level.

In some examples, to support evaluating the energy level, the energy level component 1240 may be configured as or otherwise support a means for determining whether the energy level is greater than an energy level threshold.

In some examples, the information is configured to activate the amplifier based on the energy level being greater than the energy level threshold.

In some examples, the information is configured to deactivate the amplifier based on the energy level being less than the energy level threshold.

In some examples, to support evaluating the energy level, the energy level component 1240 may be configured as or otherwise support a means for determining that the energy level corresponds to an energy state of a set of multiple energy states, where the updated operating status corresponds to the energy state.

In some examples, each energy state of the set of multiple energy states is associated with a respective operating status of the amplifier.

In some examples, to support evaluating the energy level, the energy level component 1240 may be configured as or otherwise support a means for evaluating a charging rate or a discharging rate of the power source.

In some examples, the reference signal component 1245 may be configured as or otherwise support a means for evaluating a reference signal measurement relative to the one or more criteria, where the information is configured to update the operating status based on the reference signal measurement.

In some examples, the reference signal measurement is a reference signal received power, a reference signal received quality, a signal to interference and nose ratio, a reference signal pathloss, a received signal strength, or a combination thereof.

In some examples, the one or more criteria include one or more reference signal measurement thresholds.

In some examples, the one or more criteria include a delta in the reference signal measurement relative to a prior reference signal measurement.

In some examples, the communication parameter component 1250 may be configured as or otherwise support a means for identifying a communication parameter for communications with a reader UE, where the information is configured to update the operating status based on the communication parameter.

In some examples, the communication parameter includes a data rate, a symbol duration, a modulation and coding scheme, a traffic priority, a reliability target, a packet error rate, or a combination thereof.

In some examples, the feedback component 1255 may be configured as or otherwise support a means for receiving, from the EH-capable device, feedback corresponding to a communication transmitted to the EH-capable device, where the information is configured to update the operating status based on whether the feedback is an acknowledgment or a negative acknowledgment.

In some examples, to support evaluating the one or more criteria, the feedback component 1255 may be configured as or otherwise support a means for determining that a quantity of consecutive negative acknowledgments corresponding to communications transmitted to the EH-capable device satisfies a threshold quantity of negative acknowledgments, where the information is configured to update the operating status based on the threshold quantity of negative acknowledgments being satisfied.

In some examples, to support evaluating the one or more criteria, the distance component 1260 may be configured as or otherwise support a means for determining a distance between the reader UE and the EH-capable device, where the information is configured to update the operating status based on the distance.

In some examples, to support evaluating the one or more criteria, the timer component 1265 may be configured as or otherwise support a means for determining that a timer associated with a current operating status is expired, where the information is configured to update the operating status based on expiration of the timer.

In some examples, to support evaluating the one or more criteria, the criteria identification component 1225 may be configured as or otherwise support a means for determining a slot location or a symbol location used for communications with the EH-capable device, where the information is configured to update the operating status based on the slot location or the symbol location.

In some examples, to support evaluating the one or more criteria, the evaluation component 1230 may be configured as or otherwise support a means for evaluating a buffer state associated with communications with the EH-capable device, where the information is configured to update the operating status based on the buffer state.

In some examples, to support evaluating the buffer state, the evaluation component 1230 may be configured as or otherwise support a means for evaluating the buffer state relative to a buffer state threshold.

In some examples, to support transmitting the information, the reporting component 1235 may be configured as or otherwise support a means for transmitting a wake-up signal.

In some examples, the wireless device is a network entity, a reader UE, a transmitter UE, or both a reader and a transmitter UE.

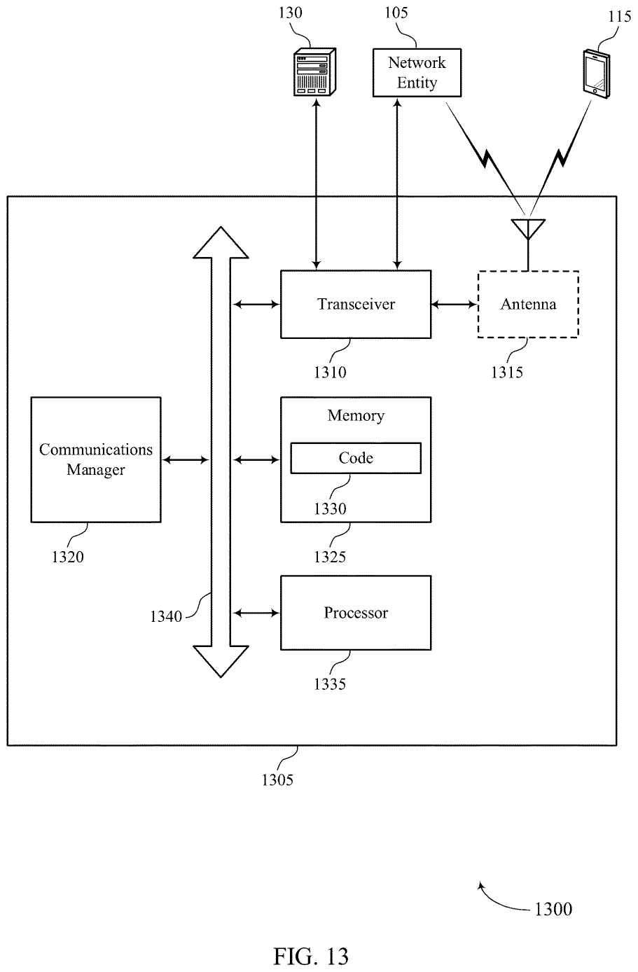

FIG. 13 shows a diagram of a system 1300 including a device 1305 that supports conditions to adjust an amplifier for energy harvesting devices in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting conditions to adjust an amplifier for energy harvesting devices). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communication at a wireless communications device in accordance with examples as disclosed herein. For example, the communications manager 1320 may be configured as or otherwise support a means for identifying one or more criteria associated with an operating status of an amplifier of an energy harvesting (EH)-capable device, where the EH-capable device is configured to transition between an energy harvesting state and an active state in accordance with an energy level of a power source associated with EH-capable device. The communications manager 1320 may be configured as or otherwise support a means for evaluating the one or more criteria based on communications with the EH capable device. The communications manager 1320 may be configured as or otherwise support a means for transmitting, to the EH-capable device based on evaluating the one or more criteria, information that is configured to update the operating status of the amplifier of the EH-capable device.

By including or configuring the communications manager 1320 in accordance with examples as described herein, the device 1305 may support techniques for improved communication reliability and power consumption at the EH-capable device.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, the processor 1335, the memory 1325, the code 1330, or any combination thereof. For example, the code 1330 may include instructions executable by the processor 1335 to cause the device 1305 to perform various aspects of conditions to adjust an amplifier for energy harvesting devices as described herein, or the processor 1335 and the memory 1325 may be otherwise configured to perform or support such operations.

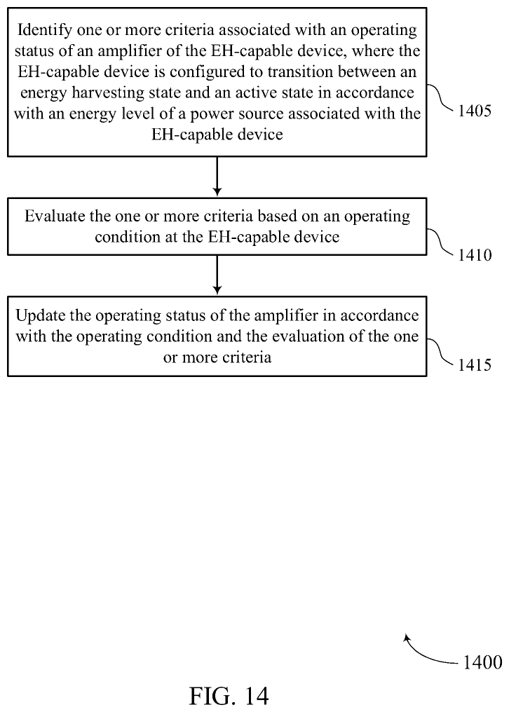

FIG. 14 shows a flowchart illustrating a method 1400 that supports conditions to adjust an amplifier for energy harvesting devices in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include identifying one or more criteria associated with an operating status of an amplifier of the EH-capable device, where the EH-capable device is configured to transition between an energy harvesting state and an active state in accordance with an energy level of a power source associated with the EH-capable device. The operations of 1405 may be performed in accordance with examples as disclosed herein. In some examples, aspects of the operations of 1405 may be performed by a criteria identification component 825 as described with reference to FIG. 8.

At 1410, the method may include evaluating the one or more criteria based on an operating condition at the EH-capable device. The operations of 1410 may be performed in accordance with examples as disclosed herein. In some examples, aspects of the operations of 1410 may be performed by an evaluation component 830 as described with reference to FIG. 8.

At 1415, the method may include updating the operating status of the amplifier in accordance with the operating condition and the evaluation of the one or more criteria. The operations of 1415 may be performed in accordance with examples as disclosed herein. In some examples, aspects of the operations of 1415 may be performed by an updating component 835 as described with reference to FIG. 8.

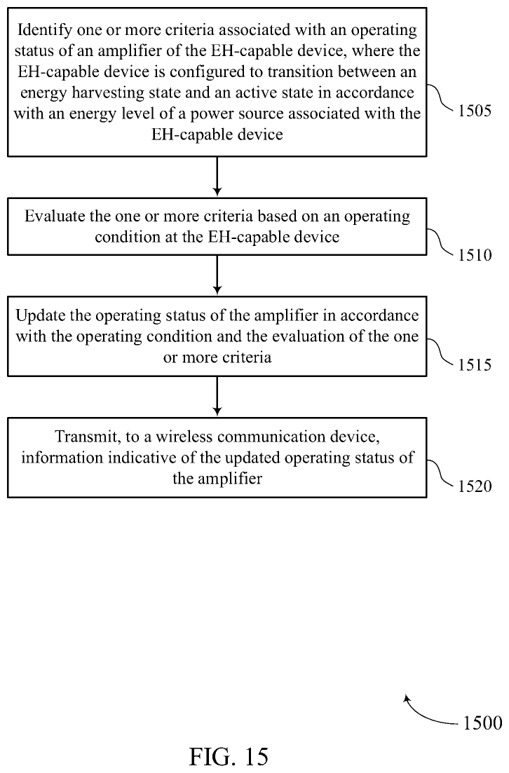

FIG. 15 shows a flowchart illustrating a method 1500 that supports conditions to adjust an amplifier for energy harvesting devices in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include identifying one or more criteria associated with an operating status of an amplifier of the EH-capable device, where the EH-capable device is configured to transition between an energy harvesting state and an active state in accordance with an energy level of a power source associated with the EH-capable device. The operations of 1505 may be performed in accordance with examples as disclosed herein. In some examples, aspects of the operations of 1505 may be performed by a criteria identification component 825 as described with reference to FIG. 8.

At 1510, the method may include evaluating the one or more criteria based on an operating condition at the EH-capable device. The operations of 1510 may be performed in accordance with examples as disclosed herein. In some examples, aspects of the operations of 1510 may be performed by an evaluation component 830 as described with reference to FIG. 8.

At 1515, the method may include updating the operating status of the amplifier in accordance with the operating condition and the evaluation of the one or more criteria. The operations of 1515 may be performed in accordance with examples as disclosed herein. In some examples, aspects of the operations of 1515 may be performed by an updating component 835 as described with reference to FIG. 8.

At 1520, the method may include transmitting, to a wireless communication device, information indicative of the updated operating status of the amplifier. The operations of 1520 may be performed in accordance with examples as disclosed herein. In some examples, aspects of the operations of 1520 may be performed by a reporting component 840 as described with reference to FIG. 8.

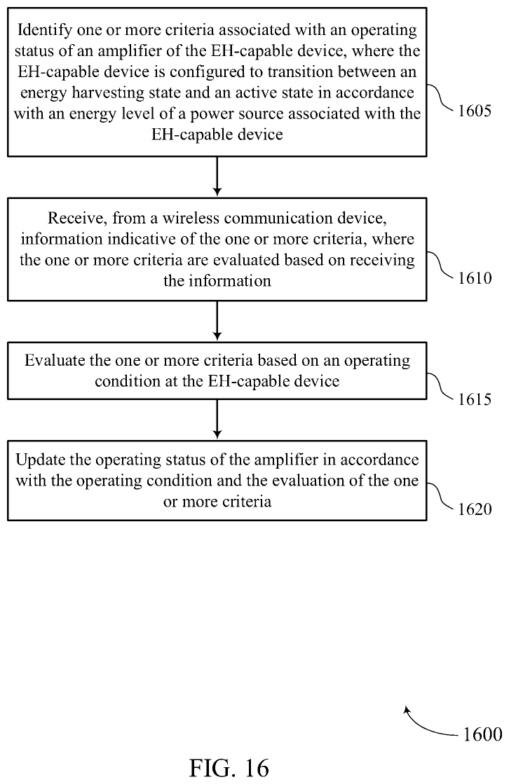

FIG. 16 shows a flowchart illustrating a method 1600 that supports conditions to adjust an amplifier for energy harvesting devices in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include identifying one or more criteria associated with an operating status of an amplifier of the EH-capable device, where the EH-capable device is configured to transition between an energy harvesting state and an active state in accordance with an energy level of a power source associated with the EH-capable device. The operations of 1605 may be performed in accordance with examples as disclosed herein. In some examples, aspects of the operations of 1605 may be performed by a criteria identification component 825 as described with reference to FIG. 8.

At 1610, the method may include receiving, from a wireless communication device, information indicative of the one or more criteria, where the one or more criteria are evaluated based on receiving the information. The operations of 1610 may be performed in accordance with examples as disclosed herein. In some examples, aspects of the operations of 1610 may be performed by a criteria identification component 825 as described with reference to FIG. 8.

At 1615, the method may include evaluating the one or more criteria based on an operating condition at the EH-capable device. The operations of 1615 may be performed in accordance with examples as disclosed herein. In some examples, aspects of the operations of 1615 may be performed by an evaluation component 830 as described with reference to FIG. 8.

At 1620, the method may include updating the operating status of the amplifier in accordance with the operating condition and the evaluation of the one or more criteria. The operations of 1620 may be performed in accordance with examples as disclosed herein. In some examples, aspects of the operations of 1620 may be performed by an updating component 835 as described with reference to FIG. 8.

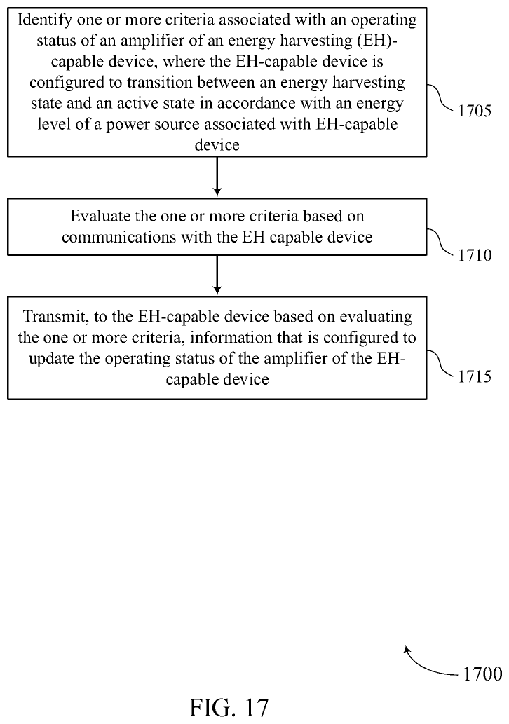

FIG. 17 shows a flowchart illustrating a method 1700 that supports conditions to adjust an amplifier for energy harvesting devices in accordance with one or more aspects of the present disclosure. The operations of the method 1700 may be implemented by a UE or a network entity or its components as described herein. For example, the operations of the method 1700 may be performed by a UE 115 as described with reference to FIGS. 1 through 9 or a network entity as described with reference to FIGS. 1 through 5 and 10 through 13. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1705, the method may include identifying one or more criteria associated with an operating status of an amplifier of an energy harvesting (EH)-capable device, where the EH-capable device is configured to transition between an energy harvesting state and an active state in accordance with an energy level of a power source associated with EH-capable device. The operations of 1705 may be performed in accordance with examples as disclosed herein. In some examples, aspects of the operations of 1705 may be performed by a criteria identification component 825 or a criteria identification component 1225 as described with reference to FIGS. 8 and 12.

At 1710, the method may include evaluating the one or more criteria based on communications with the EH capable device. The operations of 1710 may be performed in accordance with examples as disclosed herein. In some examples, aspects of the operations of 1710 may be performed by an evaluation component 830 or an evaluation component 1230 as described with reference to FIGS. 8 and 12.

At 1715, the method may include transmitting, to the EH-capable device based on evaluating the one or more criteria, information that is configured to update the operating status of the amplifier of the EH-capable device. The operations of 1715 may be performed in accordance with examples as disclosed herein. In some examples, aspects of the operations of 1715 may be performed by a reporting component 840 or a reporting component 1235 as described with reference to FIGS. 8 and 12.

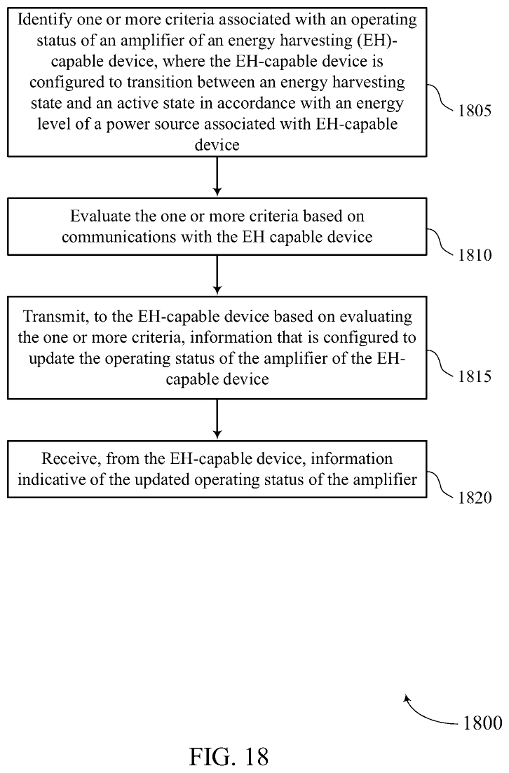

FIG. 18 shows a flowchart illustrating a method 1800 that supports conditions to adjust an amplifier for energy harvesting devices in accordance with one or more aspects of the present disclosure. The operations of the method 1800 may be implemented by a UE or a network entity or its components as described herein. For example, the operations of the method 1800 may be performed by a UE 115 as described with reference to FIGS. 1 through 9 or a network entity as described with reference to FIGS. 1 through 5 and 10 through 13. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1805, the method may include identifying one or more criteria associated with an operating status of an amplifier of an energy harvesting (EH)-capable device, where the EH-capable device is configured to transition between an energy harvesting state and an active state in accordance with an energy level of a power source associated with EH-capable device. The operations of 1805 may be performed in accordance with examples as disclosed herein. In some examples, aspects of the operations of 1805 may be performed by a criteria identification component 825 or a criteria identification component 1225 as described with reference to FIGS. 8 and 12.

At 1810, the method may include evaluating the one or more criteria based on communications with the EH capable device. The operations of 1810 may be performed in accordance with examples as disclosed herein. In some examples, aspects of the operations of 1810 may be performed by an evaluation component 830 or an evaluation component 1230 as described with reference to FIGS. 8 and 12.

At 1815, the method may include transmitting, to the EH-capable device based on evaluating the one or more criteria, information that is configured to update the operating status of the amplifier of the EH-capable device. The operations of 1815 may be performed in accordance with examples as disclosed herein. In some examples, aspects of the operations of 1815 may be performed by a reporting component 840 or a reporting component 1235 as described with reference to FIGS. 8 and 12.

At 1820, the method may include receiving, from the EH-capable device, information indicative of the updated operating status of the amplifier. The operations of 1820 may be performed in accordance with examples as disclosed herein. In some examples, aspects of the operations of 1820 may be performed by a criteria identification component 825 or a criteria identification component 1225 as described with reference to FIGS. 8 and 12.

The following provides an overview of aspects of the present disclosure:

Aspect 1: A method for wireless communications at an energy harvesting (EH)-capable device, comprising: identifying one or more criteria associated with an operating status of an amplifier of the EH-capable device, wherein the EH-capable device is configured to transition between an energy harvesting state and an active state in accordance with an energy level of a power source associated with the EH-capable device; evaluating the one or more criteria based at least in part on an operating condition at the EH-capable device; and updating the operating status of the amplifier in accordance with the operating condition and the evaluation of the one or more criteria.

Aspect 2: The method of aspect 1, further comprising: transmitting, to a wireless communication device, information indicative of the updated operating status of the amplifier.

Aspect 3: The method of any of aspects 1 through 2, wherein identifying the one or more criteria comprises: receiving, from a wireless communication device, information indicative of the one or more criteria, wherein the one or more criteria are evaluated based at least in part on receiving the information.

Aspect 4: The method of any of aspects 1 through 3, wherein updating the operating status of the amplifier comprises: adjusting a gain of the amplifier, activating the amplifier, or deactivating the amplifier based at least in part on evaluating the one or more criteria.

Aspect 5: The method of any of aspects 1 through 4, wherein evaluating the one or more criteria comprises: evaluating, as the operating condition, the energy level of the power source relative to the one or more criteria, wherein the operating status is updated based at least in part on the energy level.

Aspect 6: The method of aspect 5, wherein evaluating the energy level comprises: determining whether the energy level is greater than an energy level threshold.

Aspect 7: The method of aspect 6, wherein updating the operating status of the amplifier comprises: activating the amplifier based at least in part on determining that the energy level is greater than the energy level threshold.

Aspect 8: The method of any of aspects 6 through 7, wherein updating the operating status of the amplifier comprises: deactivating the amplifier based at least in part on determining that the energy level is less than the energy level threshold.

Aspect 9: The method of any of aspects 5 through 8, further comprising: determining that the energy level corresponds to an energy state of a plurality of energy states, wherein the updated operating status corresponds to the energy state.

Aspect 10: The method of aspect 9, wherein each energy state of the plurality of energy states is associated with a respective operating status of the amplifier.

Aspect 11: The method of any of aspects 5 through 10, wherein evaluating the energy level comprises: evaluating a charging rate or a discharging rate of the power source.

Aspect 12: The method of any of aspects 5 through 11, wherein the power source is a battery.

Aspect 13: The method of any of aspects 1 through 12, wherein evaluating the one or more criteria comprises: evaluating, as the operating condition, a reference signal measurement relative to the one or more criteria, wherein the operating status is updated based at least in part on the reference signal measurement.

Aspect 14: The method of aspect 13, wherein the reference signal measurement is a reference signal received power, a reference signal received quality, a signal to interference and nose ratio, a reference signal pathloss, a received signal strength, or a combination thereof.

Aspect 15: The method of any of aspects 13 through 14, wherein the one or more criteria comprise one or more reference signal measurement thresholds.

Aspect 16: The method of any of aspects 13 through 15, wherein the one or more criteria comprise a delta in the reference signal measurement relative to a prior reference signal measurement.

Aspect 17: The method of any of aspects 1 through 16, further comprising: identifying, as the operating condition, a communication parameter for communications with a wireless communication device, wherein the operating status is updated based at least in part on the identified communication parameter.

Aspect 18: The method of aspect 17, wherein the communication parameter comprises a data rate, a symbol duration, a modulation and coding scheme, a traffic priority, a reliability target, a packet error rate, or a combination thereof.

Aspect 19: The method of any of aspects 1 through 18, further comprising: transmitting, to a wireless communication device, feedback corresponding to a communication received from the wireless communication device, wherein the operating status is updated based at least in part on whether the feedback is an acknowledgment or a negative acknowledgment.

Aspect 20: The method of any of aspects 1 through 19, wherein evaluating the one or more criteria comprises: determining that a quantity of consecutive negative acknowledgments corresponding to communications received from a wireless communication device satisfies a threshold quantity of negative acknowledgments, wherein the operating status is updated based at least in part on the threshold quantity of negative acknowledgments being satisfied.

Aspect 21: The method of any of aspects 1 through 20, wherein evaluating the one or more criteria comprises: determining, as the operating condition, a distance between the EH-capable device and a wireless communication device, wherein the operating status is updated based at least in part on the distance.

Aspect 22: The method of any of aspects 1 through 21, wherein evaluating the one or more criteria comprises: determining that a timer associated with a current operating status is expired, wherein the operating condition is updated based at least in part on expiration of the timer.

Aspect 23: The method of any of aspects 1 through 22, further comprising: receiving, from a wireless communication device, information indicating one or more times for adjusting the operating condition for the amplifier, wherein the operating condition is updated based at least in part on the one or more times.

Aspect 24: The method of aspect 23, wherein receiving the information indicating the one or more times comprises: receiving layer 1 signaling, layer 2 signaling, layer 3 signaling, or a combination thereof.

Aspect 25: The method of any of aspects 23 through 24, wherein the information indicates the one or more times using one or more timers, as one or more slots or symbols, cycle conditions, or a combination thereof.

Aspect 26: The method of any of aspects 1 through 25, wherein evaluating the one or more criteria comprises: evaluating, as the operating condition, a current status of a discontinuous reception cycle associated with the EH-capable device, wherein the operating status is updated based at least in part on the current status of the discontinuous reception cycle.

Aspect 27: The method of any of aspects 1 through 26, wherein evaluating the one or more criteria comprises: receiving, from a wireless communication device and as the operating condition, a wake up signal, wherein the operating status is updated based at least in part on receiving the wake up signal.

Aspect 28: The method of any of aspects 1 through 27, wherein the amplifier is a low-noise amplifier, a power amplifier, a tunnel diode, or a combination thereof.

Aspect 29: A method for wireless communication at a wireless communications device, comprising: identifying one or more criteria associated with an operating status of an amplifier of an energy harvesting (EH)-capable device, wherein the EH-capable device is configured to transition between an energy harvesting state and an active state in accordance with an energy level of a power source associated with EH-capable device; evaluating the one or more criteria based at least in part on communications with the EH capable device; and transmitting, to the EH-capable device based at least in part on evaluating the one or more criteria, information that is configured to update the operating status of the amplifier of the EH-capable device.

Aspect 30: The method of aspect 29, wherein the information is configured to activate or deactivate the amplifier or adjust a gain of the amplifier.

Aspect 31: The method of any of aspects 29 through 30, further comprising: receiving, from the EH-capable device, information indicative of the updated operating status of the amplifier.

Aspect 32: The method of any of aspects 29 through 31, further comprising: receiving, from the EH-capable device, information indicative of an operating condition of the EH-capable device, wherein the operating condition is evaluated relative to the one or more criteria and the information is transmitted based at least in part on the operating condition.

Aspect 33: The method of any of aspects 29 through 32, further comprising: evaluating the energy level of the power source associated with the EH-capable device relative to the one or more criteria, wherein the information is based at least in part on the energy level.

Aspect 34: The method of aspect 33, wherein evaluating the energy level comprises: determining whether the energy level is greater than an energy level threshold.

Aspect 35: The method of aspect 34, wherein the information is configured to activate the amplifier based at least in part on the energy level being greater than the energy level threshold.

Aspect 36: The method of any of aspects 34 through 35, wherein the information is configured to deactivate the amplifier based at least in part on the energy level being less than the energy level threshold.

Aspect 37: The method of any of aspects 33 through 36, wherein evaluating the energy level comprises: determining that the energy level corresponds to an energy state of a plurality of energy states, wherein the updated operating status corresponds to the energy state.

Aspect 38: The method of aspect 37, wherein each energy state of the plurality of energy states is associated with a respective operating status of the amplifier.

Aspect 39: The method of any of aspects 33 through 38, wherein evaluating the energy level comprises: evaluating a charging rate or a discharging rate of the power source.

Aspect 40: The method of any of aspects 29 through 39, further comprising: evaluating a reference signal measurement relative to the one or more criteria, wherein the information is configured to update the operating status based at least in part on the reference signal measurement.

Aspect 41: The method of aspect 40, wherein the reference signal measurement is a reference signal received power, a reference signal received quality, a signal to interference and nose ratio, a reference signal pathloss, a received signal strength, or a combination thereof.

Aspect 42: The method of any of aspects 40 through 41, wherein the one or more criteria comprise one or more reference signal measurement thresholds.

Aspect 43: The method of any of aspects 40 through 42, wherein the one or more criteria comprise a delta in the reference signal measurement relative to a prior reference signal measurement.

Aspect 44: The method of any of aspects 29 through 43, further comprising: identifying a communication parameter for communications with a reader UE, wherein the information is configured to update the operating status based at least in part on the communication parameter.

Aspect 45: The method of aspect 44, wherein the communication parameter comprises a data rate, a symbol duration, a modulation and coding scheme, a traffic priority, a reliability target, a packet error rate, or a combination thereof.

Aspect 46: The method of any of aspects 29 through 45, further comprising: receiving, from the EH-capable device, feedback corresponding to a communication transmitted to the EH-capable device, wherein the information is configured to update the operating status based at least in part on whether the feedback is an acknowledgment or a negative acknowledgment.

Aspect 47: The method of any of aspects 29 through 46, wherein evaluating the one or more criteria comprises: determining that a quantity of consecutive negative acknowledgments corresponding to communications transmitted to the EH-capable device satisfies a threshold quantity of negative acknowledgments, wherein the information is configured to update the operating status based at least in part on the threshold quantity of negative acknowledgments being satisfied.

Aspect 48: The method of any of aspects 29 through 47, wherein evaluating the one or more criteria comprises: determining a distance between a reader UE and the EH-capable device, wherein the information is configured to update the operating status based at least in part on the distance.

Aspect 49: The method of any of aspects 29 through 48, wherein evaluating the one or more criteria comprises: determining that a timer associated with a current operating status is expired, wherein the information is configured to update the operating status based at least in part on expiration of the timer.

Aspect 50: The method of any of aspects 29 through 49, wherein evaluating the one or more criteria comprises: determining a slot location or a symbol location used for communications with the EH-capable device, wherein the information is configured to update the operating status based at least in part on the slot location or the symbol location.

Aspect 51: The method of any of aspects 29 through 50, wherein evaluating the one or more criteria comprises: evaluating a buffer state associated with communications with the EH-capable device, wherein the information is configured to update the operating status based at least in part on the buffer state.

Aspect 52: The method of aspect 51, wherein evaluating the buffer state comprises: evaluating the buffer state relative to a buffer state threshold.

Aspect 53: The method of any of aspects 29 through 52, wherein transmitting the information comprises: transmitting a wake-up signal.

Aspect 54: The method of any of aspects 29 through 53, wherein the wireless device is a network entity, a reader UE, a transmitter UE, or both a reader and a transmitter UE.

Aspect 55: An apparatus for wireless communications at an energy harvesting (EH)-capable device, comprising a processor; memory coupled with the processor; and instructions stored in the memory and executable by the processor to cause the apparatus to perform a method of any of aspects 1 through 28.

Aspect 56: An apparatus for wireless communications at an energy harvesting (EH)-capable device, comprising at least one means for performing a method of any of aspects 1 through 28.

Aspect 57: A non-transitory computer-readable medium storing code for wireless communications at an energy harvesting (EH)-capable device, the code comprising instructions executable by a processor to perform a method of any of aspects 1 through 28.

Aspect 58: An apparatus for wireless communication at a wireless communications device, comprising a processor; memory coupled with the processor; and instructions stored in the memory and executable by the processor to cause the apparatus to perform a method of any of aspects 29 through 54.

Aspect 59: An apparatus for wireless communication at a wireless communications device, comprising at least one means for performing a method of any of aspects 29 through 54.

Aspect 60: A non-transitory computer-readable medium storing code for wireless communication at a wireless communications device, the code comprising instructions executable by a processor to perform a method of any of aspects 29 through 54.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communications at an energy harvesting (EH)-capable device, comprising:
a processor;
memory coupled with the processor; and
instructions stored in the memory and executable by the processor to cause the apparatus to:
identify one or more criteria associated with an operating status of an amplifier of the EH-capable device, wherein the EH-capable device is configured to transition between an energy harvesting state and an active state in accordance with an energy level of a power source associated with the EH-capable device;
evaluate the one or more criteria based at least in part on an operating condition at the EH-capable device; and
update the operating status of the amplifier in accordance with the operating condition and the evaluation of the one or more criteria.

2. The apparatus of claim 1, wherein the instructions are further executable by the processor to cause the apparatus to:
transmit, to a wireless communication device, information indicative of the updated operating status of the amplifier.

3. The apparatus of claim 1, wherein the instructions to identify the one or more criteria are executable by the processor to cause the apparatus to:
receive, from a wireless communication device, information indicative of the one or more criteria, wherein the one or more criteria are evaluated based at least in part on receiving the information.

4. The apparatus of claim 1, wherein the instructions to update the operating status of the amplifier are executable by the processor to cause the apparatus to:
adjust a gain of the amplifier, activate the amplifier, or deactivate the amplifier based at least in part on evaluating the one or more criteria.

5. The apparatus of claim 1, wherein the instructions to evaluate the one or more criteria are executable by the processor to cause the apparatus to:
evaluate, as the operating condition, the energy level of the power source relative to the one or more criteria, wherein the operating status is updated based at least in part on the energy level.

6. The apparatus of claim 5, wherein the instructions to evaluate the energy level are executable by the processor to cause the apparatus to:
determine whether the energy level is greater than an energy level threshold.

7. The apparatus of claim 5, wherein the instructions are further executable by the processor to cause the apparatus to:
determine that the energy level corresponds to an energy state of a plurality of energy states, wherein the updated operating status corresponds to the energy state.

8. The apparatus of claim 7, wherein each energy state of the plurality of energy states is associated with a respective operating status of the amplifier.

9. The apparatus of claim 5, wherein the instructions to evaluate the energy level are executable by the processor to cause the apparatus to:
evaluate a charging rate or a discharging rate of the power source.

10. The apparatus of claim 1, wherein the instructions to evaluate the one or more criteria are executable by the processor to cause the apparatus to:
evaluate, as the operating condition, a reference signal measurement relative to the one or more criteria, wherein the operating status is updated based at least in part on the reference signal measurement.

11. The apparatus of claim 10, wherein the one or more criteria comprise one or more reference signal measurement thresholds.

12. The apparatus of claim 10, wherein the one or more criteria comprise a delta in the reference signal measurement relative to a prior reference signal measurement.

13. The apparatus of claim 1, wherein the instructions are further executable by the processor to cause the apparatus to:
identify, as the operating condition, a communication parameter for communications with a wireless communication device, wherein the operating status is updated based at least in part on the identified communication parameter.

14. The apparatus of claim 13, wherein the communication parameter comprises a data rate, a symbol duration, a modulation and coding scheme, a traffic priority, a reliability target, a packet error rate, or a combination thereof.

15. The apparatus of claim 1, wherein the instructions are further executable by the processor to cause the apparatus to:
transmit, to a wireless communication device, feedback corresponding to a communication received from the wireless communication device, wherein the operating status is updated based at least in part on whether the feedback is an acknowledgment or a negative acknowledgment.

16. The apparatus of claim 1, wherein the instructions to evaluate the one or more criteria are executable by the processor to cause the apparatus to:
determine that a quantity of consecutive negative acknowledgments corresponding to communications received from a wireless communication device satisfies a threshold quantity of negative acknowledgments, wherein the operating status is updated based at least in part on the threshold quantity of negative acknowledgments being satisfied.

17. The apparatus of claim 1, wherein the instructions to evaluate the one or more criteria are executable by the processor to cause the apparatus to:
determine, as the operating condition, a distance between the EH-capable device and a wireless communication device, wherein the operating status is updated based at least in part on the distance.

18. The apparatus of claim 1, wherein the instructions to evaluate the one or more criteria are executable by the processor to cause the apparatus to:
determine that a timer associated with a current operating status is expired, wherein the operating condition is updated based at least in part on expiration of the timer.

19-23. (canceled)

24. An apparatus for wireless communication at a wireless communications device, comprising:
a processor;
memory coupled with the processor; and
instructions stored in the memory and executable by the processor to cause the apparatus to:
identify one or more criteria associated with an operating status of an amplifier of an energy harvesting (EH)-capable device, wherein the EH-capable device is configured to transition between an energy harvesting state and an active state in accordance with an energy level of a power source associated with EH-capable device;
evaluate the one or more criteria based at least in part on communications with the EH capable device; and
transmit, to the EH-capable device based at least in part on evaluating the one or more criteria, information that is configured to update the operating status of the amplifier of the EH-capable device.

25-28. (canceled)

29. A method for wireless communications at an energy harvesting (EH)-capable device, comprising:
identifying one or more criteria associated with an operating status of an amplifier of the EH-capable device, wherein the EH-capable device is configured to transition between an energy harvesting state and an active state in accordance with an energy level of a power source associated with the EH-capable device;
evaluating the one or more criteria based at least in part on an operating condition at the EH-capable device; and
updating the operating status of the amplifier in accordance with the operating condition and the evaluation of the one or more criteria.

30. (canceled)
